(19) United States
(12) Patent Application Publication
(10) Pub. No.: US 2025/0274608 A1
(43) Pub. Date: Aug. 28, 2025

(54) GEOMETRY MODE DETERMINATION

(71) Applicant: TENCENT TECHNOLOGY (SHENZHEN) COMPANY LIMITED, Shenzhen (CN)

(72) Inventor: Wenjie ZHU, Shenzhen (CN)

(73) Assignee: TENCENT TECHNOLOGY (SHENZHEN) COMPANY LIMITED, Shenzhen, GD (CN)

(21) Appl. No.: 19/208,533

(22) Filed: May 14, 2025

Related U.S. Application Data
(63) Continuation of application No. PCT/CN2024/076451, filed on Feb. 6, 2024.

(30) Foreign Application Priority Data
Mar. 14, 2023 (CN) 202310283064.6

(51) Int. Cl. H04N 19/597; H04N 19/96

(52) U.S. Cl. CPC H04N 19/597; H04N 19/96

(57) ABSTRACT

Some aspects of the disclosure provide a method of point cloud decoding by a decoder. In some examples, a bitstream of coded information of a point cloud is received. According to the coded information, respective geometry information of a plurality of first nodes in the point cloud are obtained. A geometry mode of a current node is determined according to the respective geometry information of the plurality of first nodes. The current node is a current to-be-decoded node in the point cloud. The plurality of first nodes include at least one of: a reference node of the current node, a child node of the reference node, a decoded child node of the current node, and/or a to-be-decoded child node of the current node. Apparatus and non-transitory computer-readable storage medium counterpart embodiments are also contemplated.

### RELATED APPLICATIONS

The present application is a continuation of International Application No. PCT/CN2024/076451, filed on Feb. 6, 2024, which claims priority to Chinese Patent Application No. 202310283064.6, filed on Mar. 14, 2023. The entire disclosures of the prior applications are hereby incorporated by reference.

### FIELD OF THE TECHNOLOGY

Embodiments of this disclosure relate to the technical field of point cloud coding and decoding, including a geometry mode determination.

BACKGROUND OF THE DISCLOSURE

Point cloud, i.e. point cloud data, is a group of points in a 3 dimension (3D) space. Each point has an associated attribute such as a color and a material. The point cloud data may be configured for reconstructing an object or a scene into such a combination of points.

In the related art, the point cloud data is coded mainly based on an octree. For the point cloud data in the 3D space, an octree partition mode is evenly dividing a preset bounding box layer by layer, where each node has eight child nodes, and whether each child node in the octree is occupied is indicated by using ‘1’ or ‘0’. During coding based on the octree, 3D coordinate information of the point cloud data is converted into a corresponding Morton code by querying a Morton order table, and a corresponding point of each layer of octree is obtained according to ordering of each Morton code.

However, for point cloud data having a special geometry mode, coding and decoding efficiency based on an octree in the related art is relatively low.

### SUMMARY

Embodiments of this disclosure provide a geometry mode determining method and apparatus, a device, and a storage medium, to optimally determine a geometry mode of a node by a decoder, thereby improving coding and decoding efficiency. The following technical solution is adopted.

Some aspects of the disclosure provide a method of point cloud decoding by a decoder. In some examples, a bitstream of coded information of a point cloud is received. According to the coded information, respective geometry information of a plurality of first nodes in the point cloud are obtained. A geometry mode of a current node is determined according to the respective geometry information of the plurality of first nodes. The current node is a current to-be-decoded node in the point cloud. The plurality of first nodes include at least one of: a reference node of the current node, a child node of the reference node, a decoded child node of the current node, and/or a to-be-decoded child node of the current node.

Some aspects of the disclosure provide an information processing apparatus for point cloud decoding, the information processing apparatus includes processing circuitry configured to perform the method of point cloud decoding

According to an aspect of the embodiments of this disclosure, a geometry mode determining method is provided. The method is applied to a decoder. The method is performed by a decoder device. The method includes: obtaining geometry information of a first node; and determining a geometry mode of a current node according to the geometry information of the first node, where the current node is a current to-be-decoded node. The first node is at least one of the following nodes: a reference node; a child node of the reference node; a decoded child node of the current node; or a to-be-decoded child node of the current node.

According to an aspect of the embodiments of this disclosure, a geometry mode determining method is provided. The method is applied to a coder. The method is performed by a coder device. The method includes: obtaining geometry information of a first node; and determining a geometry mode of a current node according to the geometry information of the first node, where the current node is a current to-be-coded node. The first node is at least one of the following nodes: a reference node; a child node of the reference node; a decoded child node of the current node; or a to-be-decoded child node of the current node.

According to an aspect of the embodiments of this disclosure, a geometry mode determining apparatus is provided. The apparatus is implementable as a decoder. The apparatus includes: an obtaining module, configured to obtain geometry information of a first node; and a determining module, configured to determine a geometry mode of a current node according to the geometry information of the first node, where the current node is a current to-be-decoded node. The first node is at least one of the following nodes: a reference node; a child node of the reference node; a decoded child node of the current node; or a to-be-decoded child node of the current node.

According to an aspect of the embodiments of this disclosure, a geometry mode determining apparatus is provided. The apparatus is implementable as a coder. The apparatus includes: an obtaining module, configured to obtain geometry information of a first node; and a determining module, configured to determine a geometry mode of a current node according to the geometry information of the first node, where the current node is a current to-be-coded node. The first node is at least one of the following nodes: a reference node; a child node of the reference node; a decoded child node of the current node; or a to-be-decoded child node of the current node.

According to an aspect of the embodiments of this disclosure, a computer device is provided. The computer device includes a processor (an example of processing circuitry) and a memory. The memory has at least one program stored therein. The at least one program is loaded and executed by the processor to implement the foregoing geometry mode determining method.

According to an aspect of the embodiments of this disclosure, a computer-readable storage medium (e.g., non-transitory computer-readable storage medium) is provided. The computer-readable storage medium has at least one program stored therein. The at least one program is loaded and executed by a processor to implement the foregoing geometry mode determining method.

According to an aspect of the embodiments of this disclosure, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, to cause the computer device to perform the foregoing geometry mode determining method.

The technical solutions provided in the embodiments of this disclosure include at least the following beneficial effects.

A decoder device and a coder device separately obtain geometry information of a first node, and then determine a geometry mode of a current node according to the geometry information. In combination with geometry information in an octree partition process, the geometry mode of the current node is optimally determined, thereby improving efficiency of decoding point cloud data by the decoder device and coding the point cloud data by the coder device, and improving the efficiency of coding and decoding the point cloud data.

### BRIEF DESCRIPTION OF THE DRAWINGS

FIG. 1 is a framework diagram of a point cloud application according to an embodiment of this disclosure.

FIG. 2 is a schematic diagram of a point cloud coding framework according to an embodiment of this disclosure.

FIG. 3 is a schematic diagram of a point cloud bounding box according to an embodiment of this disclosure.

FIG. 4 is a schematic diagram of a node space according to an embodiment of this disclosure.

FIG. 5 is a schematic diagram of octree coding according to an embodiment of this disclosure.

FIG. 6 is a schematic diagram of block structure coding according to an embodiment of this disclosure.

FIG. 7 is a simplified block diagram of a communication system according to an embodiment of this disclosure.

FIG. 8 is a schematic diagram of a placement mode of a point cloud coder and a point cloud decoder in a streaming environment according to an embodiment of this disclosure.

FIG. 9 is a flowchart of a geometry mode determining method according to an embodiment of this disclosure.

FIG. 10 is a schematic diagram of an order of selecting a decoded node at a fixed position according to an embodiment of this disclosure.

FIG. 11 is a flowchart of a geometry mode determining method according to another embodiment of this disclosure.

FIG. 12 is a schematic diagram of a position relationship of a reference node, a decoded child node of a current node, and a to-be-decoded child node according to an embodiment of this disclosure.

FIG. 13 is a flowchart of a geometry mode determining method according to another embodiment of this disclosure.

FIG. 14 is a flowchart of a reference node selecting method according to an embodiment of this disclosure.

FIG. 15 is a flowchart of a reference node selecting method according to another embodiment of this disclosure.

FIG. 16 is a flowchart of a geometry mode determining method according to another embodiment of this disclosure.

FIG. 17 is a block diagram of a geometry mode determining apparatus according to an embodiment of this disclosure.

FIG. 18 is a block diagram of a geometry mode determining apparatus according to an embodiment of this disclosure.

FIG. 19 is a schematic structural diagram of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Point cloud, i.e. point cloud data, can refer to a set of discrete points which represent spatial structures and surface attributes of three-dimensional objects or scenes with irregular distribution in a 3D space. Each point in the point cloud data at least has three-dimensional position information, and may further have a color, a material, or other information according to different application scenes. Usually, each point in the point cloud data has a same number of additional attributes.

The point cloud data may flexibly and conveniently express a space structure and surface attributes of a three-dimensional object or scene, and therefore is widely applied. The main application scenes may be classified into two categories: a) a machine-sensible point cloud, for example, an autonomous navigation system, a real-time inspection system, a geographical information system, a visual sorting robot, or a disaster rescue and relief robot; and b) an eye-sensible point cloud, for example, a point cloud application scene such as digital culture heritage, free viewpoint broadcasting, three-dimensional immersive communication, or three-dimensional immersive interaction.

Obtaining approaches of the point cloud data include and are not limited to computer generation, 3D laser scanning, and 3D photogrammetry. A computer may generate point cloud data of virtual three-dimensional objects and scenes. The 3D scanning may obtain point cloud data of static real-world three-dimensional objects or scenes, and millions of point cloud data may be obtained per second. The 3D photogrammetry may obtain point clouds of dynamic real-world three-dimensional objects or scenes, and tens of millions of point cloud data may be obtained per second. Furthermore, in the medical field, point cloud data of a biological tissue organ may be obtained through magnetic resonance imaging (MRI), computed tomography (CT), and electromagnetic positioning information. These technologies reduce costs and a time period of obtaining point cloud data, and improve precision of the data. The change of a mode of obtaining point cloud data makes it possible to obtain a large amount of point cloud data. With the continuous accumulation of large-scale point cloud data, the efficient storage, transmission, release, sharing, and standardization of point cloud data have become the key to point cloud data applications.

Point cloud data may be partitioned into an intensive point cloud and a sparse point cloud according to a data obtaining mode. Specifically, a 3D coordinate measuring machine obtains a relatively small number of points, with a relatively large spacing between points and a relatively sparse point cloud. At this moment, the sparse point cloud is obtained. A 3D laser scanner or a camera scanner obtains a relatively large number of points, with a relatively small spacing between points and a relatively intensive point cloud. At this moment, the intensive point cloud is obtained. Point cloud data may be partitioned into a static point cloud and a dynamic point cloud according to a time sequence type of data. Specifically, an object is static, and a device obtaining the point cloud data is also static. At this moment, the static point cloud is obtained. The object is moving but the device obtaining the point cloud data is static. At this moment, the dynamic point cloud is obtained.

FIG. 1 shows a framework diagram of a point cloud application according to an embodiment of this disclosure. For example, geometry-based point cloud coding (Geometry-based Point Cloud Compression, G-PCC) data is used. In FIG. 1, a real-world virtual scene (A) is captured by a group of cameras or a camera device 11 with a plurality of lenses and sensors at a transmitter. An acquisition result is source point cloud data (B). One or more point cloud frames are coded by a G-PCC coder 12 into a coded G-PCC bit stream (E), including a coded geometry bit stream and attribute bit stream. Then, a file encapsulator 13 encapsulates, according to a specific media container file format, the one or more coded bit streams (E) into a media file (F) for file playback, or into a sequence (Fs) of an initialization segment and a media segment for streaming.

The file encapsulator 13 further includes metadata into a file or a segment, where (Fs) is transmitted to a client through a transmission mechanism 14. A file encapsulator 15 of the client decapsulates (Fs), to obtain one or more decapsulated coded bit streams (E′), a G-PCC decoder 16 decodes (E′), to obtain one or more decoded point cloud frames (D′), and a presentation component 17 presents a virtual scene (A′) corresponding to the one or more point cloud frames (D′) on a display component 18.

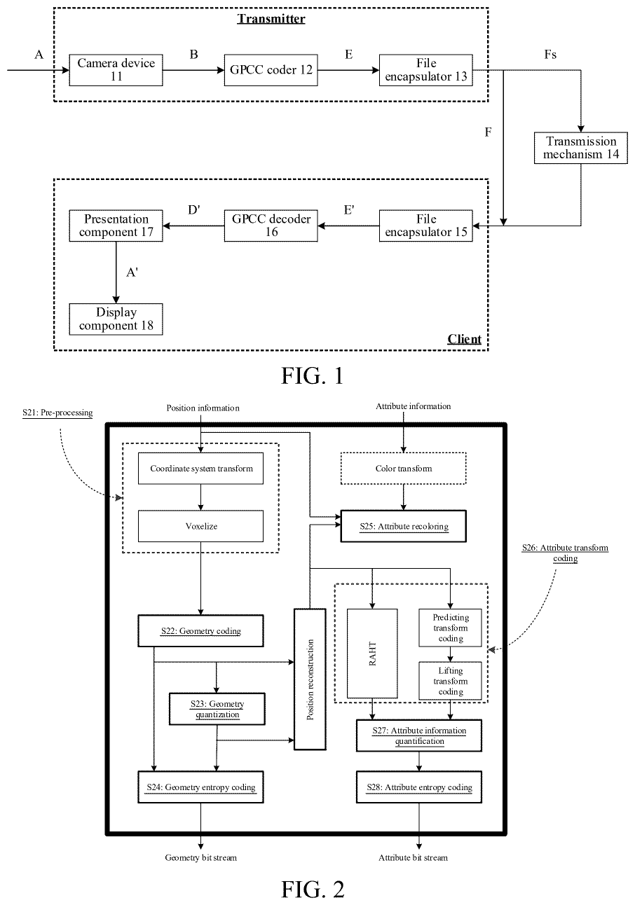

The following briefly describes a point cloud coding technology with reference to FIG. 2. FIG. 2 is a schematic diagram of a point cloud coding framework according to an embodiment of this disclosure. Point cloud data may be partitioned into an intensive point cloud and a sparse point cloud according to a data obtaining mode, and may be partitioned into a static point cloud and a dynamic point cloud according to a time sequence type of data. Main point cloud coding technologies may be partitioned into geometry-based point cloud coding and projection-based point cloud coding for different point cloud data types. For example, G-PCC in an international video audio coding/decoding standard, moving picture experts group (MPEG), and a China national digital audio video coding standard-point cloud compression (AVS-PCC) standard are used for description.

Both the G-PCC and the AVS-PCC are specific to a static sparse point cloud, and coding frameworks thereof are approximately the same. As shown in FIG. 2, the point cloud coding includes geometry coding and attribute information coding. For the geometry coding, main operations and processing include:
S21: Pre-processing: including transformation of coordinates (Transform coordinates) and voxelization (Voxelize). Through the operations of scaling and translating, point cloud data in a 3D space is converted into an integer form, and a minimum geometry position thereof is moved to a coordinate origin.
S22: Geometry coding (Geometry encoding): The geometry coding may include a plurality of modes, which may be used in different conditions. For example, the geometry coding may include octree-based geometry coding and trisoup-based geometry coding.
   Octree-based geometry coding: An octree is a tree-shaped data structure. During partition of the 3D space, a preset bounding box is evenly partitioned, and each node has eight child nodes. Whether occupancy is performed on each child node of the octree is indicated by using ‘1’ and ‘0’, to obtain an occupancy code as a code stream of point cloud geometry information.
   Trisoup-based geometry coding: The point cloud is partitioned into blocks of a particular size, an intersection of a surface of the point cloud at an edge of the block is positioned, and a triangle is constructed. The geometry information is compressed by coding the intersection position.
S23: Geometry quantization: Quantization fineness is usually determined by a quantization parameter (QP). A larger value of the QP indicates that coefficients within a larger value range are quantized to a same output. Therefore, larger distortion and a lower bit rate are usually caused. On the contrary, a relatively small QP value indicates that coefficients in a relatively small value range are quantized into a same output. Therefore, relatively small distortion is usually caused, and a corresponding relatively high bit rate is also caused. In the point cloud coding, quantization is directly performed on coordinate information of a point.
S24: Geometry entropy coding (Geometry Entropy Encoding): By using octree-based geometry coding as an example, statistical compression coding is performed on the occupancy code of the octree, and a binary (0 or 1) compressed code stream is finally outputted. The statistical coding is a lossless coding mode, which may effectively reduce a code rate required to express a same signal. In an example, a statistical coding mode, such as content adaptive binary arithmetic coding (CABAC) can be used.

For the attribute information coding, main operations and processing include:
S25: Attribute recoloring: In a case of lossy coding, after the geometry information coding, a coder needs to decode and reconstruct geometry information. To be specific, coordinate information of each point of a 3D point cloud is recovered. The original point cloud data is searched for attribute information corresponding to one or more neighbor points, and the attribute information is used as attribute information of the reconstruction point.
S26: Attribute transform coding (Transform): The attribute transform coding includes three modes, which may be used in different conditions.
   Predicting transform coding (Predicting Transform): A subset of points is selected according to a distance, the point cloud is partitioned into a plurality of different levels (Level of Detail, LoD), and representation from coarse to refined point cloud is implemented. Bottom-up prediction may be implemented between adjacent layers. To be specific, attribute information of a point introduced in a refined layer is predicted from a neighbor point in a coarse layer, to obtain a corresponding residual signal. A point at the lowest layer is used as reference information for coding.
   Lifting transform coding (Lifting Transform): Based on LoD adjacent layer prediction, a weight update policy of a neighborhood point is introduced, to finally obtain a prediction attribute value of each point and obtain a corresponding residual signal.
   Region adaptive hierarchical transform (RAHT) coding: RAHT is performed on the attribute information, to convert a signal into a transform domain, which is referred to as a transform coefficient.
S27: Attribute information quantization (Attribute Quantization): Quantization fineness is usually determined by a QP. In the predicting transform coding and the lifting transform coding, entropy coding is performed on a residual value after quantization. In the RAHT, entropy coding is performed on a transform coefficient after quantization.
S28: Attribute entropy coding: The quantized attribute residual signal or transform coefficient is usually finally compressed by using run length coding and arithmetic coding. Corresponding information such as a coding mode and a quantization parameter is also coded by using an entropy coder.

According to the foregoing coding process, after obtaining a compressed code stream at a decoder, the decoder first performs entropy decoding, to obtain various mode information, quantized geometry information, and attribute information. On one hand, the geometry information is inversely quantized, to obtain reconstructed 3D point position information. On the other hand, the attribute information is inversely quantized to obtain residual information, and a reference signal is confirmed according to the adopted transform mode, to obtain reconstructed attribute information, which corresponds to the geometry information one by one in order to generate outputted reconstructed point cloud data.

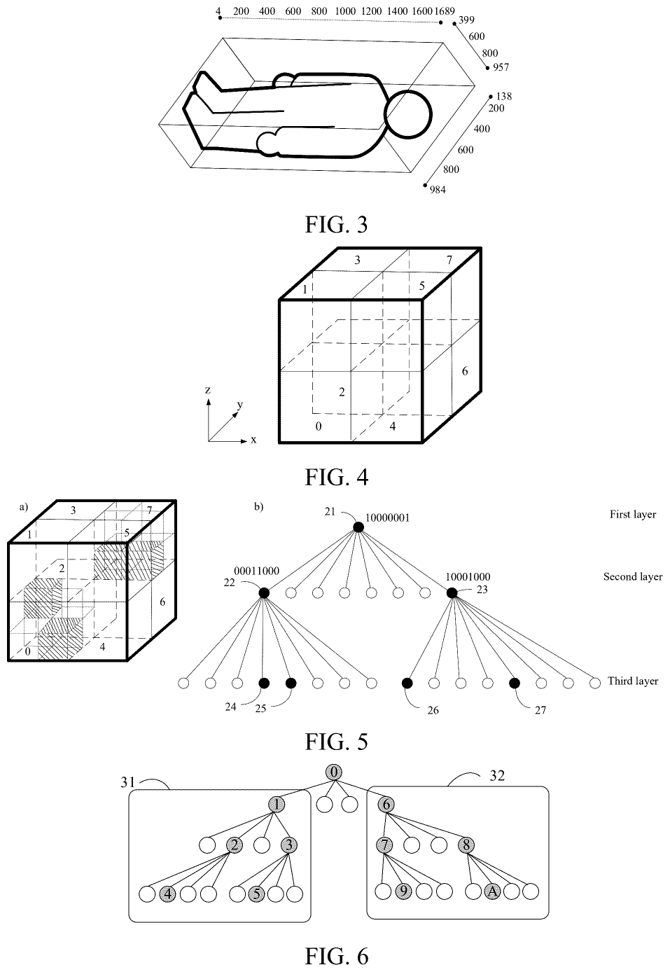

The following briefly describes a pre-processing operation in the point cloud coding technology with reference to FIG. 3. FIG. 3 is a schematic diagram of a point cloud bounding box according to an embodiment of this disclosure. The point cloud bounding box is a smallest cuboid that includes all data points in an input point cloud. To be specific, the point cloud bounding box shown in FIG. 3 includes all data points of a human-shaped point cloud and the point cloud bounding box is the smallest cuboid of cuboids including all the data points of the point cloud.

In the pre-processing operation, an origin and a size of the point cloud bounding box need to be determined. The coordinates of a floating point type of a k^{th} data point of the input point cloud may be represented as (x^{k}, y^{k}, z^{k}), where k is an integer less than K, and K is a number of data points in the point cloud.

First, a maximum value and a minimum value of the point cloud in each coordinate axis direction in a three-dimensional coordinate system are determined, and obtained in the following mode:

$${x}^{min} = min ( {x}^{0} , {x}^{1} , … , {x}^{k - 1} ) \\ {y}^{min} = min ( {y}^{0} , {y}^{1} , … , {y}^{k - 1} ) \\ {z}^{min} = min ( {z}^{0} , {z}^{1} , … , {z}^{k - 1} ) \\ {x}^{max} = max ( {x}^{0} , {x}^{1} , … , {x}^{k - 1} ) \\ {y}^{max} = max ( {y}^{0} , {y}^{1} , … , {y}^{k - 1} ) \\ {z}^{max} = max ( {z}^{0} , {z}^{1} , … , {z}^{k - 1} )$$

where the function min (s⁰, s¹, . . . , s^{k-1}) represents minimization of a current input, the function max (s⁰, s¹, . . . , s^{k-1}) represents maximization of the current input, and a value of s in the function min (s⁰, s¹, . . . , s^{k-1}) may be x, y, or z.

Next, an origin (x^{origin}, y^{origin}, z^{origin}) of the point cloud bounding box is calculated, and obtained in the following mode:

x^{origin}=int(floor(x^{min}))

y^{origin}=int(floor(y^{min}))

z^{origin}=int(floor(z^{min}))
where the function int(s) represents rounding, the function floor(s) returns a maximum integer value less than or equal to s, and a value of s in the function floor(s) may be x, y, or z.

In addition, sizes of the point cloud surrounding box in directions of three-dimensional coordinate axes, namely, an X axis, a Y axis, and a Z axis, may be calculated as follows:

$${BoundingBoxSize}_{x} = int ( {x}^{max} - {x}^{origin} ) + 1 \\ {BoundingBoxSize}_{y} = int ( {y}^{max} - {y}^{origin} ) + 1 \\ {BoundingBoxSize}_{z} = int ( {z}^{max} - {z}^{origin} ) + 1$$

where the function int(s) represents rounding, BoundingBoxSizes represents a size in a direction of an s axis, and a value of s may be x, y, or z.

The following explains some terms involved in this disclosure.

Node Space: Point cloud data is partitioned according to a tree structure, and a space of a point cloud corresponding to a node in the tree structure is a node space.

FIG. 4 shows a schematic diagram of an octree node space according to an embodiment of this disclosure. FIG. 4 shows space positions of child nodes of a node in a partition process of an octree by using an implementation of a right-handed coordinate system as an example. The node space of the node is evenly partitioned into eight child node spaces, to represent eight child nodes of the node, and the eight child nodes are separately numbered. FIG. 4 shows an implementation example of numbering a child node.

Low-Plane/High-Plane: An octree node space shown in FIG. 4 is partitioned into a high plane and a low plane. The high plane and the low plane are relative to a coordinate axis.

For example, an example in which the node space is partitioned into a high plane and a low plane in the Z axis direction is used. Child nodes 1, 3, 5, and 7 are located in the high plane, and child nodes 0, 2, 4, and 6 are located in the low plane. To be specific, child nodes 1, 3, 5, and 7 are high-plane child nodes, and child nodes 0, 2, 4, and 6 are low-plane child nodes. For another example, an example in which the node space is partitioned into a high plane and a low plane in the X axis direction is used. Child nodes 0, 1, 2, and 3 are located in the low plane, and child nodes 4, 5, 6, and 7 are located in the high plane. For another example, an example in which the node space is partitioned into a high plane and a low plane in the Y axis direction is used. Child nodes 0, 1, 4, and 5 are located in the low plane, and child nodes 2, 3, 6, and 7 are located in the high plane.

In some embodiments, in a case that a current node is offset in a direction of a first coordinate axis and a direction of a second coordinate axis to select a reference node, a high plane and a low plane are partitioned in a direction of a third coordinate axis. For example, in a case that the current node is offset in an XY direction to select a reference node, a high plane and a low plane are partitioned in the Z axis direction.

A coordinate axis representation mode, a high/low-plane partition mode, and a child node numbering mode shown in FIG. 4 are cases in some examples. This is not limited in this disclosure.

Octree Coding Mode: An octree is a tree-shaped data structure. Currently, a point cloud is partitioned mainly by using an octree structure in a G-PCC or an AVS-PCC. For point cloud data in a 3D space, an octree partition mode is evenly dividing a preset bounding box layer by layer, where each node has eight child nodes. Whether occupancy is performed on each child node of the octree is indicated by using ‘1’ and ‘0’, to obtain an occupancy code as a code stream of point cloud geometry information.

Construction of the octree is implemented based on a Morton order. To be specific, 3D coordinate information of the point cloud data is converted into a corresponding Morton code by querying a Morton order table. A corresponding point of each layer of the octree is obtained according to ordering of the Morton codes. Currently, a mainstream point cloud coding technology is to represent the point cloud data by using octree partition, and different processing procedures are used for geometry information and attribute information.

FIG. 5 shows an octree coding mode according to an embodiment of this disclosure. a) on the left of FIG. 5 shows a schematic diagram of a node space of a node, and (b) on the right of FIG. 5 shows a schematic diagram of octree coding corresponding thereto. A shadow part in the schematic diagram of the node space indicates being occupied, and a black solid circle in the schematic diagram of the octree code indicates being occupied.

An entire cube in (a) on the left of FIG. 5 corresponds to a node 21 on a first layer of an octree in (b) on the right. First, the node space of the node is partitioned into eight child node spaces. As shown in (a), a child node 0 and a child node 7 in the figure are occupied, which correspond to a 0^{th} child node 22 and a 7^{th} child node 23 on a second layer of the octree in b). Each occupied child node is further partitioned into eight child nodes, to obtain a third layer of the octree. As shown in b), a 4^{th} child node 24 and a 5^{th} child node 25 of the 0^{th} child node 22 on the second layer are occupied, a 0^{th} child node 26 and a 5^{th} child node 27 of the 7^{th} child node 23 on the second layer are occupied, and so on.

By octree partition, each occupied node may be coded. For example, by binary coding, 1 represents that a child node is occupied, and 0 represents that a child node is unoccupied. Therefore, a code of the node 21 on the first layer is 10000001, a code of the 0^{th} child node 22 on the second layer is 00011000, a code of the 7^{th} child node 23 on the second layer is 10001000, and so on.

Furthermore, quadtree coding, binary tree coding, and the like are similar to the octree coding. This is not limited in this disclosure.

Block Structure Coding: The block structure coding is configured for coding a tree-shaped data structure after performing spatial partition on the point cloud by using the tree-shaped data structure. In the block structure coding method, a concept similar to a coded block in video coding is introduced, and a three-dimensional space is partitioned into a plurality of non-overlapping coded macro blocks having a size of (2^{d}^{ₓ}, 2^{d}^{_{y}}, 2^{d}^{_{z}}), where each macro block is used as a basic coding unit. A user may set an octree partition depth d or control the size of the 3D macro block through a parameter nodeSizeLog2. When the octree is partitioned into nodes having a size of (2^{d}^{ₓ}, 2^{d}^{_{y}}, 2^{d}^{_{z}}) and the following conditions are satisfied, each node is coded based on a macro block (Largest Coding Unit, LCU):

nodeSizeLog2>max(dₓ, d_{y}, d_{z})

FIG. 6 shows, based on an example in which a tree-shaped structure is a 2D quadtree, a schematic diagram of a block structure coding method according to an embodiment of this disclosure. As shown in FIG. 6, coding starts according to a macro block order at a second layer partitioned of the 2D quadtree, where each macro block may be considered as an independent tree partition structure. To be specific, a left macro block 31 and a right macro block 32 are separately coded.

In an implementation example, each macro block is internally traversed in scope first. To be specific, traversed coding is performed from top to bottom according to a layer order. Such a block structure coding method brings great flexibility. Different geometry coding methods may be used on each macro block according to characteristics of the macro block, or attribute coding may be performed on a macro block after geometry coding is completed. In this way, attribute coding can be performed without waiting for geometry coding of an entire point cloud.

Parent Node and Child Node: The parent node is located on a layer above a current node, and a node space of the current node is an entire or partial node space of the parent node. A child node is located on a next layer of the current node, and a node space of the child node is an entire or partial current node. For example, the node 21 in FIG. 5 is the parent node of the node 22, and the node 26 is the child node of the node 23. For another example, the node 26 and the node 27 are child nodes (or referred to as sibling nodes, same-layer nodes, brother nodes, or the like) of the same parent node.

Neighbor Node: The neighbor node is another node adjacent to a node, for example, a parent node of the node, another child node of the parent node, or another node intersecting with the node. The neighbor node may be applied to many octree algorithms, for example, determining a spatial position of the node and querying adjacent data elements.

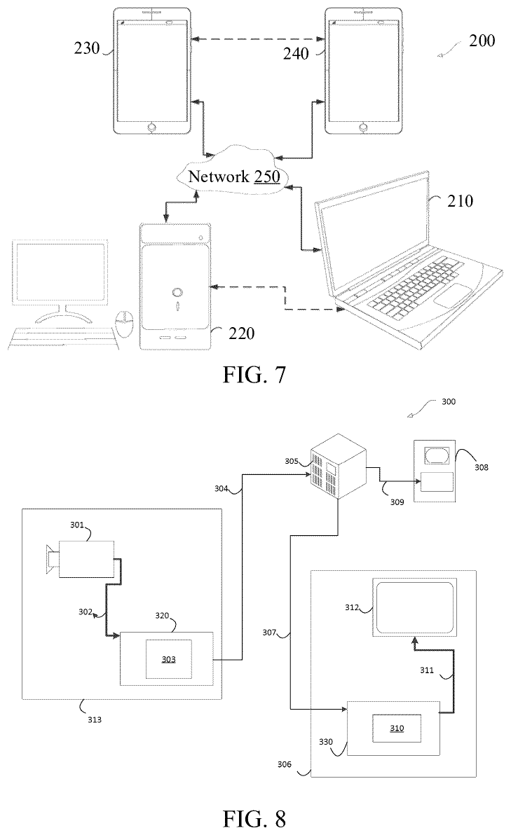

FIG. 7 shows a simplified block diagram of a communication system according to an embodiment of this disclosure. A communication system 200 includes a plurality of devices. The plurality of devices may communicate with each other via, for example, a network 250. The network 250 may be a wired network or a wireless network. For example, the communication system 200 includes a first device 210 and a second device 220 interconnected via the network 250. In this embodiment of FIG. 7, the first device 210 and the second device 220 perform unidirectional data transmission. For example, the first device 210 may code point cloud data to obtain coded point cloud data. For example, the point cloud data may be a point cloud frame stream acquired by the first device 210. The first device 210 transmits the coded point cloud data to the second device 220 via the network 250. The coded point cloud data is transmitted in a form of one or more coded point cloud code streams (or referred to as point cloud bit streams). The second device 220 may receive the coded point cloud data from the network 250, decode the coded point cloud data to recover the point cloud data, and present a point cloud based on the recovered point cloud data. The unidirectional data transmission is relatively common in applications such as media services.

In another embodiment, the communication system 200 includes a third device 230 and a fourth device 240 that perform bidirectional transmission of the coded point cloud data. For bidirectional data transmission, each of the third device 230 and the fourth device 240 may code the point cloud data for transmission to the other of the third device 230 and the fourth device 240 via the network 250. Each of the third device 230 and the fourth device 240 may further receive the coded point cloud data transmitted by the other of the third device 230 and the fourth device 240, decode the coded point cloud data to recover the point cloud data, and display the point cloud on an accessible display apparatus according to the recovered point cloud data.

In this embodiment of FIG. 7, the first device 210, the second device 220, the third device 230, and the fourth device 240 may be computer devices such as a server, a personal computer (PC), and an intelligent terminal, but the principles disclosed in this disclosure may not be limited thereto. This embodiment of this disclosure is applicable to a PC, a mobile phone, a tablet computer, a virtual reality/augmented reality device, a media player, and/or a dedicated video conference device. The network 250 represents any number of networks for transmitting the coded point cloud data between the first device 210, the second device 220, the third device 230, and the fourth device 240, and includes, for example, a wired and/or wireless communication network. The communication network 250 may exchange data in a circuit-switched and/or packet-switched channel. The network may include a telecommunication network, a local area network, a wide area network, and/or the Internet. For the purpose of this disclosure, unless explained below, an architecture and a topology of the network 250 may be inconsequential to operations disclosed in this disclosure.

As an embodiment, FIG. 8 shows a placement mode of a video coder and a video decoder in a streaming environment. The subject disclosed in this disclosure may be equally applicable to other applications supporting a point cloud, including, for example, a virtual 3D conference, a digital TV, storing a compressed point cloud on a digital medium including a compact disc (CD), a digital versatile disc (DVD), a memory stick, and the like.

A streaming system 300 may include an acquisition subsystem 313. The acquisition subsystem may include a point cloud source 301 such as a three-dimensional camera. The point cloud source 301 creates an uncompressed point cloud data stream 302. Compared with coded point cloud data 304 (or a coded point cloud code stream), the point cloud data stream 302 is depicted as a bold line to emphasize a point cloud data stream of a high data volume. The point cloud data stream 302 may be processed by an electronic apparatus 320. The electronic apparatus 320 includes a point cloud coder 303 coupled to the point cloud source 301. The point cloud coder 303 may include hardware, software, or a combination of software and hardware, to realize or implement the embodiments of the aspects of the disclosed subject as described in more detail below. Compared with the point cloud data stream 302, the coded point cloud data 304 (or the coded point cloud code stream) is depicted as a thin line, to emphasize the coded point cloud data 304 of a relatively low data volume, which may be stored on a streaming server 305 for future use. One or more streaming client subsystems, for example, a client subsystem 306 and a client subsystem 308 in FIG. 3, may access the streaming server 305 to retrieve a copy 307 and a copy 309 of the coded point cloud data 304. The client subsystem 306 may include, for example, a point cloud decoder 310 in an electronic apparatus 330. The point cloud decoder 310 decodes the incoming copy 307 of the coded point cloud data 304, and generates an output point cloud data stream 311 that may be presented on a display 312 (for example, a display screen) or another presentation apparatus (not shown). In some streaming systems, the coded point cloud data 304, point cloud data 307, and point cloud data 309 (for example, point cloud code streams) may be coded according to some point cloud coding/compression standards.

The electronic apparatus 320 and the electronic apparatus 330 may include other components (not shown). For example, the electronic apparatus 320 may include a point cloud decoder (not shown), and the electronic apparatus 330 may further include a point cloud coder (not shown). The point cloud decoder is configured to decode the received coded point cloud data 304. The point cloud coder is configured to code the point cloud data.

The technical solutions provided in this embodiment of this disclosure may be applied to an audio video coding standard (AVS) such as AVS3, or a standard supporting point cloud coding such as a next-generation video coding and decoding standard. This is not limited in this embodiment of this disclosure.

Various operations of a method provided in this embodiment of this disclosure may be performed by a coder device or a decoder device. In a process of point cloud coding and point cloud decoding, attribute prediction may be performed by using the technical solutions provided in this embodiment of this disclosure. The coder device and the decoder device may both be computer devices. The computer device is an electronic device having data calculation, processing, and storage capabilities, such as a PC, a mobile phone, a tablet computer, a media player, a virtual reality/augmented reality device, a dedicated video conference device, or a server.

In addition, the method provided in this disclosure may be used alone or may be combined with another method in any order. The coder device and the decoder device based on the method provided in this disclosure may be separately implemented by one or more processors or one or more integrated circuits.

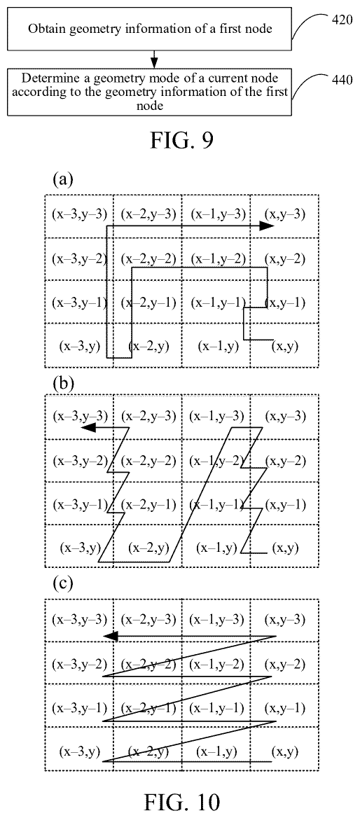

FIG. 9 shows a flowchart of a geometry mode determining method according to an embodiment of this disclosure. For ease of description, various operations are performed by only a computer device. The method is performed by a decoder/a decoder device/a computer device. The method may include all or some of the following operations 420 and 440.

### Operation 420: Obtain Geometry Information of a First Node

A current node is a node decoded currently.

The first node is a node providing information for determining a geometry mode of the current node. The first node is geometrically associated with the current node. The first node includes decoded information of historical nodes and/or neighborhood information of the current node. For example, the first node is a neighbor node of the current node. For another example, the first node is a pre-decoded node of the current node. For another example, the first node is a parent node of the current node, and so on.

In some embodiments, the first node is at least one of the following nodes:
a reference node;
a child node of the reference node;
a decoded child node of the current node; or
a to-be-decoded child node of the current node.

In some embodiments, the reference node is selected from at least one of the following nodes:
a decoded node;
a non-null decoded node;
a decoded node on a same layer as the current node;
a non-null decoded node on a same layer as the current node;
a decoded node at a fixed position;
a non-null decoded node at a fixed position;
a parent node of the current node;
a neighbor node located at a same parent node as the current node; or
a child node of the neighbor node located at the same parent node as the current node.

The decoded node is a pre-decoded node, and includes the parent node of the current node. The non-null decoded node is a pre-decoded node including at least one occupied child node. The decoded node on the same layer as the current node is a decoded node that is on the same layer as the current node in octree partition, namely does not include the parent node of the current node. The non-null decoded node on the same layer as the current node is a decoded node that is on the same layer as the current node in octree partition and has at least one child node occupied. The decoded node at the fixed position is a decoded node that is at a fixed position relative to the current node. The non-null decoded node at the fixed position is a decoded node that is at a fixed position relative to the current node and has at least one child node occupied. The fixed position may be understood as a fixed offset position, a specified position, or the like.

In some embodiments, the decoded node at the fixed position is obtained by setting a preset quantity of an offset. The decoded node at the fixed position includes at least one of the following (an example in which coordinates of the current node are (x, y, z) is used):
a decoded node corresponding to the current node being offset by a first preset quantity in a direction of a first coordinate axis, where the first preset quantity is a preset offset quantity of the offset in the direction of the first coordinate axis, and in an example in which the first coordinate axis is an X axis, if the first preset quantity is set to -1 or -2, the reference node is (x-1, y, z) or (x-2, y, z);
a decoded node corresponding to the current node being offset by a second preset quantity in a direction of a second coordinate axis, where the second preset quantity is a preset offset quantity of the offset in the direction of the second coordinate axis, and in an example in which the second coordinate axis is a Y axis, if the second preset quantity is set to -1 or -2, the reference node is (x, y-1, z) or (x, y-2, z); or
a decoded node corresponding to the current node being offset by a third preset quantity in the direction of the first coordinate axis and offset by a fourth preset quantity in the direction of the second coordinate axis, where the third preset quantity is a preset offset quantity of the offset in the direction of the first coordinate axis, the fourth preset quantity is a preset offset quantity of the offset in the direction of the second coordinate axis, and in an example in which the first coordinate axis is an X axis and the second coordinate axis is a Y axis, if the third preset quantity is set to -1 and the fourth preset quantity is set to -1, the reference node is (x-1, y-1, z).

The first coordinate axis and the second coordinate axis are coordinate axes in two different directions in a three-dimensional coordinate system.

In some embodiments, at least one of the first preset quantity, the second preset quantity, the third preset quantity, and the fourth preset quantity is:
a default value or value group;
a corresponding value or value group when a second condition is met;
determined based on the met second condition; or
determined according to at least one type of information.

The default value or value group may be preset. The second condition and the at least one type of information are described in detail in the following embodiments.

In some embodiments, at least one of the first preset quantity, the second preset quantity, the third preset quantity, and the fourth preset quantity varies based on a corresponding offset value variation, where the offset value variation is:
a default value or value group;
a corresponding value or value group when a second condition is met;
determined based on the met second condition; or
determined according to at least one type of information.

For example, when the number of non-null nodes in the decoded node is relatively large, a relatively large offset value variation is selected, so that an offset range can be expanded, to obtain more non-null nodes.

For another example, an offset threshold xoffset in the X axis direction is determined, and an offset value variation addXoffset in the X axis direction is determined. Three fixed position nodes are selected. In a case that there are two null nodes in the selected fixed position nodes, addXoffset=2. In a case that there is one null node in the selected fixed position nodes, addXoffset=1. In a case that there is no null node in the selected fixed position nodes, addXoffset=0. The preset quantity is a sum of the offset threshold xoffset and the offset value variation addXoffset. To be specific, in a case that there are many null nodes, the preset quantity varies largely based on the offset value variation. In a case that there are few null nodes, the preset quantity varies less based on the offset value variation.

In some embodiments, at least one of the direction of the first coordinate axis and the direction of the second coordinate axis is:
a default coordinate axis direction;
a corresponding coordinate axis direction when a second condition is met;
determined based on the met second condition; or
determined according to at least one type of information.

The default coordinate axis direction may be preset. The second condition and the at least one type of information are described in detail in the following embodiments.

The second condition is related to at least one type of the following information:
geometry slice information (for example, a geometry slice density or a size of a point cloud bounding box);
a relative position of the current node;
occupancy information of a parent node of the current node;
occupancy information of a neighbor node of the current node; or
occupancy information of first k reference nodes.

The geometry slices are different geometric figures, for example, a square, a rectangle, and a circle. k may be a preset value. The relative position of the current node is information about a position of the current node relative to another node/parent node/neighbor node/reference node. The relative position of the current node may be described by using at least one of coordinates of the current node, a layer on which the current node is located, and a code. The occupancy information is information about an occupied position. For example, the occupancy information of the parent node of the current node is information about a position occupied by the parent node of the current node, and may specifically include at least one of coordinates of the current node, a layer on which the parent node of the current node is located, and a code.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

The data geometry precision may be described by using a geometry precision such as a plane position, a height, a shape, or a ratio of data.

The foregoing preset quantities and coordinate axis directions may be all default values or preset values, or partially default values and partially determined based on a second condition or related information, or all determined based on the related information, or the like. To be specific, any one of the foregoing modes of selecting the preset quantities and the coordinate axes may be selected, or a combination thereof may be used.

For example, a default value group is used as a preset quantity. For another example, the second condition is configured for indicating a parameter Q₁ of the geometry slice density. In a case that the current geometry slice density is greater than Q₁, a corresponding value k₁ is selected. Otherwise, a value k₂ is selected. For another example, there are a plurality of candidate values or a plurality of groups of candidate values meeting the second condition, and one candidate value or one group of candidate values is selected as a preset quantity. For another example, the preset quantity is determined according to the geometry slice information. In a case that the geometry slice density is relatively small, the preset quantity is increased. For another example, in a case that the current node is the only child node of the parent node, the preset quantity is increased. For another example, in a case that the neighbor node of the parent node of the current node is null, the preset quantity is increased, and the like. The mode of selecting the preset quantities and selecting the coordinate axes is not limited in this disclosure.

In some embodiments, the decoded node at the fixed position is obtained by setting a preset quantity of an offset and a fixed multiple. For example, a product of the preset quantity of the offset and the fixed multiple is an actually used offset. The decoded node at the fixed position includes at least one of the following (an example in which coordinates of the current node are (x, y, z) is used):
a decoded node corresponding to the current node being offset by a first multiple offset in a direction of a first coordinate axis, where the first multiple offset is an offset obtained by multiplying a first preset quantity by a first multiple, the first preset quantity is a preset offset quantity of the offset in the direction of the first coordinate axis, and in an example in which the first coordinate axis is an X axis, if the first preset quantity is set to -1 or -2 and the first multiple is set to 2, the reference node is (x-2, y, z) or (x-4, y, z);
a decoded node corresponding to the current node being offset by a second multiple offset in a direction of a second coordinate axis, where the second multiple offset is an offset obtained by multiplying a second preset quantity by a second multiple, the second preset quantity is a preset offset quantity of the offset in the direction of the second coordinate axis, and in an example in which the second coordinate axis is a Y axis, if the second preset quantity is set to -1 or -2 and the second multiple is set to 4, the reference node is (x, y-4, z) or (x, y-8, z); or
a decoded node corresponding to the current node being offset by a third multiple offset in the direction of the first coordinate axis and offset by a fourth multiple offset in the direction of the second coordinate axis, where the third multiple offset is an offset obtained by multiplying a third preset quantity by a third multiple, the fourth multiple offset is an offset obtained by multiplying a fourth preset quantity by a fourth multiple, the third preset quantity is a preset offset quantity of the offset in the direction of the first coordinate axis, the fourth preset quantity is a preset offset quantity of the offset in the direction of the second coordinate axis, and in an example in which the first coordinate axis is an X axis and the second coordinate axis is a Y axis, if the first preset quantity is set to m₃, the second preset quantity is set to m₄, and the third multiple and the fourth multiple are set to 1, the reference node is (x-m₃, y-m₄, z).

The first coordinate axis and the second coordinate axis are coordinate axes in two different directions in a three-dimensional coordinate system. The first multiple, the second multiple, the third multiple, and the fourth multiple are preset fixed multiples, and may be selected according to an actual situation. For example, the fixed multiple is selected based on a quantization parameter of the point cloud.

In some embodiments, at least one of the first preset quantity, the second preset quantity, the third preset quantity, the fourth preset quantity, the first multiple, the second multiple, the third multiple, and the fourth multiple is:
a default value or value group;
a corresponding value or value group when a second condition is met;
selected from a plurality of candidate values based on the met second condition; or
determined according to at least one type of information.

The default value or value group may be preset. The second condition and the at least one type of information are described in detail in the following embodiments.

In some embodiments, at least one of the direction of the first coordinate axis and the direction of the second coordinate axis is:
a default value or value group;
a corresponding value or value group when a second condition is met;
determined based on the met second condition; or
determined according to at least one type of information.

The second condition is related to at least one type of the following information:
geometry slice information;
a relative position of the current node;
occupancy information of a parent node of the current node;
occupancy information of a neighbor node of the current node; or
occupancy information of the first k reference nodes.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

In some embodiments, the decoded node at the fixed position is obtained by setting an offset threshold. The decoded node at the fixed position includes at least one of the following (an example in which coordinates of the current node are (x, y, z) is used):
a decoded node corresponding to an offset of the current node in the direction of the first coordinate axis being less than a first offset threshold, where the first offset threshold is a preset maximum offset quantity of the offset in the direction of the first coordinate axis, and in an example in which the first coordinate axis is an X axis, if the first offset threshold is set to M₁, the reference node is (x-m₁, y, z), where m₁<M₁;
a decoded node corresponding to an offset of the current node in the direction of the second coordinate axis being less than a second offset threshold, where the second offset threshold is a preset maximum offset quantity of the offset in the direction of the second coordinate axis, and in an example in which the second coordinate axis is a Y axis, if the second offset threshold is set to M₂, the reference node is (x, y-m₂, z), where m₂<M₂; or.
a decoded node corresponding to a sum of the offset of the current node in the direction of the first coordinate axis and the offset in the direction of the second coordinate axis being less than a third offset threshold, where the third offset threshold is a preset maximum sum of the offset quantities of the offsets in the direction of the second coordinate axis and in the direction of the second coordinate axis, and in an example in which the first coordinate axis is an X axis and the second coordinate axis is a Y axis, if the third offset threshold is set to M₃, the reference node is (x-m₁, y-m₂, z), where m₁+m₂<M₃.

The first coordinate axis and the second coordinate axis are coordinate axes in two different directions in a three-dimensional coordinate system.

The first offset threshold, the second offset threshold, the third offset threshold, the fourth offset threshold, the direction of the first coordinate axis, and the direction of the second coordinate axis are determined according to at least one type of the following information: a quantization parameter; a data geometry precision; a geometry slice density; a geometry slice size; a relative position of the current node; or a parent node and a neighbor node of the current node.

In some embodiments, at least one of the first offset threshold, the second offset threshold, the third offset threshold, and the fourth offset threshold is:
a default value or value group;
a corresponding value or value group when a second condition is met;
determined based on the met second condition; or
determined according to at least one type of information.

In some embodiments, at least one of the direction of the first coordinate axis and the direction of the second coordinate axis is:
a default coordinate axis direction;
a corresponding coordinate axis direction when a second condition is met;
determined based on the met second condition; or
determined according to at least one type of information.

The second condition is related to at least one type of the following information:
geometry slice information;
a relative position of the current node;
occupancy information of a parent node of the current node;
occupancy information of a neighbor node of the current node; or
occupancy information of the first k reference nodes.

The geometry slices are different geometric figures, for example, a square, a rectangle, and a circle. k may be a preset value. The relative position of the current node is information about a position of the current node relative to another node/parent node/neighbor node/reference node. The relative position of the current node may be described by using at least one of coordinates of the current node, a layer on which the current node is located, and a code. The occupancy information is information about an occupied position. For example, the occupancy information of the parent node of the current node is information about a position occupied by the parent node of the current node, and may specifically include at least one of coordinates of the current node, a layer on which the parent node of the current node is located, and a code.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

The data geometry precision may be described by using a geometry precision such as a plane position, a height, a shape, or a ratio of data.

In some embodiments, the decoded node at the fixed position is obtained by setting an offset threshold, and a number threshold is set for a number of selected decoded nodes. The number threshold may be a fixed number. The decoded node is selected based on a preset order until a fixed number of decoded nodes are selected.

In some embodiments, the decoded node at the fixed position is selected by: selecting, in a first order, a fixed number of decoded nodes meeting a first condition, where the first order is one of a preset order, a default order, a linear order, a Hilbert order, a Morton order, or a coordinate axis order. The first condition is a preset condition. For example, the node is a non-null node.

In some embodiments, a fixed number of decoded nodes meeting a selection condition are selected in a first order from the decoded node corresponding to an offset of the current node in the direction of the first coordinate axis being less than a first offset. A fixed number of decoded nodes meeting a selection condition are selected in a second order from the decoded node corresponding to an offset of the current node in the direction of the second coordinate axis being less than a second offset. A fixed number of decoded nodes meeting a selection condition are selected in a third order from the decoded node corresponding to a sum of the offset of the current node in the direction of the first coordinate axis and the offset in the direction of the second coordinate axis being less than a third offset. The first order is one of a preset order, a default order, a linear order, a Hilbert order, a Morton order, or a coordinate axis order. The second order is one of a preset order, a default order, a linear order, a Hilbert order, a Morton order, or a coordinate axis order. The third order is one of a preset order, a default order, a linear order, a Hilbert order, a Morton order, or a coordinate axis order. The first offset is at least one offset less than a first offset threshold. The second offset is at least one offset less than a second offset threshold. The third offset is at least one offset less than a third offset threshold.

In some other embodiments, a fixed number of decoded nodes meeting a selection condition are selected in a first order from the decoded node corresponding to an offset of the current node in the direction of the first coordinate axis being less than a first offset threshold. A fixed number of decoded nodes meeting a selection condition are selected in a second order from the decoded node corresponding to an offset of the current node in the direction of the second coordinate axis being less than a second offset threshold. A fixed number of decoded nodes meeting a selection condition are selected in a third order from the decoded node corresponding to a sum of the offset of the current node in the direction of the first coordinate axis and the offset in the direction of the second coordinate axis being less than a third offset threshold. The first order is one of a preset order, a default order, a linear order, a Hilbert order, a Morton order, or a coordinate axis order. The second order is one of a preset order, a default order, a linear order, a Hilbert order, a Morton order, or a coordinate axis order. The third order is one of a preset order, a default order, a linear order, a Hilbert order, a Morton order, or a coordinate axis order.

The preset order is a preset selection order of nodes at fixed positions. The default order is an order determined from a decoder or obtained by parsing a parameter set or a code stream corresponding to the current node. The coordinate axis order is an order of sequential or alternate selection according to the coordinate axes. The linear order, the Hilbert order, or the Morton order is shown with reference to FIG. 10. FIG. 10 shows a schematic diagram of an order of selecting a decoded node at a fixed position according to an embodiment of this disclosure.

Part (a) of FIG. 10 shows a schematic diagram of a Hilbert order in an X axis direction. FIG. (a) shows that in a case that an offset threshold in an X axis and an offset threshold in a Y axis are both 4, there are 16 alternative decoded nodes at fixed positions, namely, (x, y), (x-1, y), (x-1, y-1), (x, y-1), (x, y-2), (x-1, y-2), (x-2, y-2), (x-2, y-1), (x-2, y), (x-3, y), (x-3, y-1), (x-3, y-2), (x-3, y-3), (x-2, y-3), (x-1, y-3), and (x, y-3). If the number threshold is a value less than 16, sequential selection is performed according to a direction of an arrow in FIG. (a), until a fixed number of decoded nodes are selected. For example, in a case that the number threshold is 3 and the fixed number of selected nodes is also 3, (x, y), (x-1, y), and (x-1, y-1) are sequentially selected as decoded nodes at fixed positions.

Part (b) of FIG. 10 shows a schematic diagram of a morton/zigzag order in an X axis direction. FIG. (b) shows that in a case that an offset threshold in an X axis and an offset threshold in a Y axis are both 4, there are 16 alternative decoded nodes at fixed positions, namely, (x, y), (x-1, y), (x, y-1), (x-1, y-1), (x, y-2), (x-1, y-2), (x, y-3), (x-1, y-3), (x-2, y), (x-3, y), (x-2, y-1), (x-3, y-1), (x-2, y-2), (x-3, y-2), (x-2, y-3), and (x-3, y-3). If the number threshold is a value less than 16, sequential selection is performed according to a direction of an arrow in FIG. (b), until a fixed number of decoded nodes are selected. For example, in a case that the number threshold is 4 and the fixed number of selected nodes is also 4, (x, y), (x-1, y), (x, y-1), and (x-1, y-1) are sequentially selected as decoded nodes at fixed positions.

Part (c) of FIG. 10 shows a schematic diagram of a linear order in an X axis direction. FIG. (c) shows that in a case that an offset threshold in an X axis and an offset threshold in a Y axis are both 4, there are 16 alternative decoded nodes at fixed positions, namely, (x, y), (x-1, y), (x-2, y), (x-3, y), (x, y-1), (x-1, y-1), (x-2, y-1), (x-3, y-1), (x, y-2), (x-1, y-2), (x-2, y-2), (x-3, y-2), (x, y-3), (x-1, y-3), (x-2, y-3), and (x-3, y-3). If the number threshold is a value less than 16, sequential selection is performed according to a direction of an arrow in FIG. (c), until a fixed number of decoded nodes are selected. For example, in a case that the number threshold is 5 and the fixed number of selected nodes is also 5, (x, y), (x-1, y), (x-2, y), (x-3, y), and (x, y-1) are sequentially selected as decoded nodes at fixed positions.

The mode of selecting a decoded node at a fixed position is not limited to the foregoing mode. This is not limited in this disclosure.

The non-null decoded node at the fixed position is a node that has at least one child node occupied in the foregoing decoded node at the fixed position. The non-null decoded node at the fixed position may be obtained in at least one of the following modes (an example in which coordinates of the current node are (x, y, z) is used):
After the decoded node at the fixed position is obtained by using the foregoing method, a non-null decoded node is selected therefrom. For example, all decoded nodes at fixed positions are obtained within the range of an offset threshold, and all non-null nodes are selected therefrom.
A decoded node at a fixed position is selected based on the foregoing method for setting an offset threshold. In a case that the decoded node at the fixed position is a null node, an offset of thereof along a coordinate axis is increased by one. For example, if an offset threshold in an X axis direction is set to M₁, the node is (x-m₁, y, z), where m₁<M₁. If (x-m₁, y, z) is a null node, m₁=m₁+1. For another example, if an offset threshold in a Y axis direction is set to M₂, the reference node is (x, y-m₂, z), where m₂<M₂. If (x, y-m₂, z) is a null node, m₂=m₂+1.
A number threshold is set. A decoded node at a fixed position is selected based on the foregoing method for setting an offset threshold. In a case that the decoded node at the fixed position is a null node, an offset of thereof along a coordinate axis is increased by one, until a number of non-null decoded nodes at a fixed position reaches the number threshold.

In some embodiments, a fixed number of decoded nodes meeting a first condition are selected in a first order, until a fixed number (a number threshold) of decoded nodes are selected. The first order may be any one of a default order, a preset order, a Hilbert order, a Morton order, a linear order, and a coordinate axis order. The first condition is that the node is non-null.

In some embodiments, before operation 420, whether the current node is coded by using a geometry mode is determined. In a case that the current node is coded by using the geometry mode, operation 420 and operation 440 are performed.

### Operation 440: Determine a Geometry Mode of a Current Node according to the Geometry Information of the First Node

The geometry mode is mode information corresponding to an entropy decoding mode. A geometry mode of point cloud data includes an isolated point mode, a planar mode, and the like. The isolated point mode is configured for coding and/or decoding a node determined as an isolated point. The planar mode is configured for coding and/or decoding a planar mode node. Schematically, the planar mode is that reference nodes of the current node are located in a same plane, decoded child nodes of the current node are located in a same plane, or the like.

For example, it is determined that the geometry mode of the current node is a target decoding mode based on the geometry information of the first node. The target decoding mode is a decoding mode corresponding to the planar mode node.

The geometry mode of the current node is determined according to an occupancy status of the first node in a case that the first node includes a child node of the reference node. The geometry mode of the current node is determined according to a plane position of the first node in a case that the first node includes a decoded child node of the current node.

The geometry mode of the current node is determined based on the geometry information of the first node. Alternatively, the geometry mode of the current node is determined based on at least one threshold and the geometry information of the first node. To be specific, the geometry mode of the current node may be determined by using only the geometry information of the first node. Alternatively, the geometry information of the first node may be compared with at least one threshold with reference to an obtained threshold and the geometry information of the first node (for example, a child node of the reference node), to determine the geometry mode of the current node. In an example in which the first node includes a child node of the reference node and a to-be-decoded child node of the current node, the geometry mode of the current node may be determined based on at least one threshold, the child node of the reference node, and geometry information of the to-be-decoded child node of the current node. Specifically, a number of the low-plane occupancy child nodes and a number of the high-plane occupancy child nodes are statistically obtained. The geometry mode of the current node is determined based on the at least one threshold, the geometry information of the to-be-decoded child node, the number of the low-plane occupancy child nodes, and the number of the high-plane occupancy child nodes.

In some embodiments, the at least one threshold includes a first threshold, a second threshold, a third threshold, and a fourth threshold.

In some embodiments, it is determined that the current node is a first decoding mode in a case that the number of the low-plane occupancy child nodes is less than the first threshold and the number of the high-plane occupancy child nodes is greater than the second threshold. Alternatively, it is determined that the current node is a second decoding mode in a case that the number of the low-plane occupancy child nodes is greater than the third threshold and the number of the high-plane occupancy child nodes is less than the fourth threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node.

The high-plane node is a node in which occupied child nodes are all in a high plane. The low-plane node is a node in which occupied child nodes are all in a low plane. Alternatively, the high-plane node satisfies that a number of occupied child nodes in a low plane is less than a number of first child nodes and a number of occupied child nodes in a high plane is greater than a number of second child nodes. The low-plane node satisfies that the number of occupied child nodes in the low plane is greater than a number of third child nodes and the number of occupied child nodes in the high plane is less than a number of fourth child nodes. The number of first child nodes, the number of second child nodes, the number of third child nodes, and the number of fourth child nodes are preset values.

For example, a first threshold k₁, a second threshold k₂, a third threshold k₃, and a fourth threshold k₄ are set. A low-plane occupancy child node LowOccNum and a high-plane occupancy child node HighOccNum are statistically obtained. In a case that LowOccNum<k₁ and HighOccNum>k₂, it is determined that the current node is the first decoding mode. In a case that LowOccNum>k₃ and HighOccNum<k₄, it is determined that the current node is the second decoding mode.

In some embodiments, it is determined that the current node is a first decoding mode in a case that the number of the low-plane occupancy child nodes is less than the first threshold. Alternatively, it is determined that the current node is a second decoding mode in a case that the number of the high-plane occupancy child nodes is less than the second threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node.

For example, a first threshold k₁ and a second threshold k₂ are set. A low-plane occupancy child node LowOccNum and a high-plane occupancy child node HighOccNum are statistically obtained. In a case that LowOccNum<k₁, it is determined that the geometry mode of the current node is the first decoding mode. In a case that HighOccNum<k₂, it is determined that the geometry mode of the current node is the second decoding mode.

In some embodiments, it is determined that the current node is a first decoding mode in a case that the to-be-decoded child node is in a high plane, the number of the low-plane occupancy child nodes is less than the first threshold, and the number of the high-plane occupancy child nodes is greater than the second threshold. Alternatively, it is determined that the current node is a second decoding mode in a case that the to-be-decoded child node is in a low plane, the number of the low-plane occupancy child nodes is greater than the third threshold, and the number of the high-plane occupancy child nodes is less than the fourth threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node. The to-be-decoded child node is a current to-be-decoded child node in the current node.

For example, a first threshold k₁, a second threshold k₂, a third threshold k₃, and a fourth threshold k₄ are set. A low-plane occupancy child node LowOccNum and a high-plane occupancy child node HighOccNum are statistically obtained. In a case that the to-be-decoded child node is in a high plane, LowOccNum<k₁, and HighOccNum>k₂, it is determined that the current node is the first decoding mode. In a case that the to-be-decoded child node is in a low plane, LowOccNum>k₃, and HighOccNum<k₄, it is determined that the current node is the second decoding mode.

The foregoing method shows a method for determining the geometry mode of the current node based on the to-be-decoded child node and an occupancy status of the child node of the reference node. Furthermore, the geometry mode of the current node may alternatively be determined based on the to-be-decoded child node and at least one first node. For example, the geometry mode of the current node is determined based on the to-be-decoded child node, the occupancy status of the child node of the reference node, and the decoded child node of the current node. This disclosure does not limit use of the first node alone or in combination.

In some embodiments, the occupancy code is decoded, to statistically obtain the number of low-plane occupancy child nodes and the number of high-plane occupancy child nodes. In an implementation example, refer to the following operations 1 to 3.
1. Define an initialized number of reference nodes meeting a preset condition and an offset value meeting a condition. An initialized number of reference nodes meeting a preset condition is set to 0, and offset values meeting the condition are set to {−1, 0, 0}, {−2, 0, 0}, {0, −1, 0}, {0, −2, 0}, and {−1, −1, 0}.
2. Determine, based on a geometry occupancy code mapping table and the offset value meeting the condition, a low-plane occupancy code in the reference nodes and a high-plane occupancy code in the reference nodes, increase, according to the low-plane occupancy code in the reference nodes and the high-plane occupancy code in the reference nodes, the initialized number of the reference nodes meeting the preset condition, to obtain a number of the reference nodes meeting the preset condition, and check each of the low-plane occupancy code in the reference nodes and the high-plane occupancy code in the reference nodes, to separately obtain an intermediate number of the low-plane occupancy child nodes and an intermediate number of the high-plane occupancy child nodes, where the initialized number of reference nodes meeting the preset condition is increased, and may be increased by 1 for each operation, the foregoing intermediate number is a number in an operation process, and the intermediate number may alternatively be used as a final number.
3. Separately assign, based on a magnitude relationship between the number of the reference nodes meeting the preset condition and a preset value, values to the intermediate number of the low-plane occupancy child nodes and the intermediate number of the high-plane occupancy child nodes, to obtain the number of the low-plane occupancy child nodes and the number of the high-plane occupancy child nodes, where the preset value may be set to 2, when the number of reference nodes meeting the preset condition is greater than 2, values of the intermediate number of the low-plane occupancy child nodes and the intermediate number of the high-plane occupancy child nodes remain unchanged, and when the number of reference nodes meeting the preset condition is less than 2, the values of the intermediate number of the low-plane occupancy child nodes and the intermediate number of the high-plane occupancy child nodes are directly 0.

In some embodiments, for the foregoing operation of decoding the occupancy code, refer to the following code. LowOccNum represents the number of low-plane occupied child nodes in child nodes of a neighbor node of the current node. HighOccNum represents the number of high-plane occupied child nodes in the child nodes of the neighbor node of the current node.

Two variables LowOccNum and HighOccNum are initialized to 0. LowOccNum represents the number of low-plane occupied child nodes in the neighbor node of the current node. HighOccNum represents the number of high-plane occupied child nodes in the neighbor node of the current node. When the geometry slice planar mode identifier gsh_planar_mode is 1, the following operations are performed for a child node numbered as childIdx. Otherwise, LowOccNum and HighOccNum are directly 0:

```
  preNodePlanarNum = 0
  planarNodeOffset[5][3] = {{−1, 0, 0}, {−2, 0, 0}, {0, −1, 0}, {0, −2, 0}, {−1, −1,
0}}
  for(j = 0; j <=4; j ++){
  neighborOccupancyCode=GeometryNodeOccupancyCode[depth][xN+planarNod
eOffset[j][0]][yN+ planarNodeOffset[j][1][zN+planarNodeOffset[j][2]]
  neighborOccupancyHighCode=!(neighborOccupancyCode&0x55)&&(!!(neighbor
OccupancyCode&0xaa))
  neighborOccupancyLowCode=(!!(neighborOccupancyCode&0x55))&&!(neighbo
rOccupancyCode & 0xaa)
    if(neighborOccupancyHighCode ∥ neighborOccupancyLowCode)
  preNodePlanarNum += 1
      for(i = 0; i < 8; i++){
        LowOccNum += (neighborOccupancyLowCode >> i ) & 1
        HighOccNum += (neighborOccupancyHighCode >> i ) & 1
  }
  }
  LowOccNum = preNodePlanarNum > 2 ? LowOccNum : 0
  HighOccNum = preNodePlanarNum > 2 ? HighOccNum : 0
```

where preNodePlanarNum represents the number of reference nodes meeting a preset condition, neighborOccupancyCode represents a reference node occupancy code, GeometryNodeOccupancyCode represents a geometry occupancy code mapping table, planarNodeOffset represents an offset value meeting a condition, neighborOccupancyLowCode represents a low-plane occupancy code in the reference node, and neighborOccupancyHighCode represents a high-plane occupancy code in the reference node.

In some embodiments, the geometry mode of the current node is determined based on geometry information of the decoded child node of the current node.

In some embodiments, the geometry mode of the current node is determined based on the geometry information of the reference node and the geometry information of the decoded child node of the current node. For example, it is determined that the geometry mode of the current node is a first decoding mode in a case that the decoded child node of the current node and the reference node are not in the same plane and the to-be-decoded child node and the decoded child node of the current node are not in the same plane. Alternatively, it is determined that the geometry mode of the current node is a second decoding mode in a case that the decoded child node of the current node and the reference node are not in the same plane and the to-be-decoded child node and the decoded child node of the current node are in the same plane. Alternatively, it is determined that the geometry mode of the current node is a third decoding mode in a case that the decoded child node of the current node and the reference node are in the same plane and the to-be-decoded child node and the decoded child node of the current node are in the same plane. Alternatively, it is determined that the geometry mode of the current node is a fourth decoding mode in a case that the decoded child node of the current node and the reference node are in the same plane and the to-be-decoded child node and the decoded child node of the current node are not in the same plane.

In some embodiments, the reference node does not satisfy a planar mode. It is determined that a geometry mode of the to-be-decoded child node is a fifth decoding mode in a case that the decoded child node of the current node is in the same plane and the to-be-decoded child node and the decoded child node of the current node are also in the same plane.

In some embodiments, the geometry mode of the current node is determined based on geometry information of the parent node of the current node. Alternatively, the geometry mode of the current node is determined based on geometry information of a child node of a reference node located at a same parent node as the current node. Alternatively, the geometry mode of the current node is determined based on geometry information of a child node of a neighbor node located at a same parent node as the current node. Alternatively, the geometry mode of the current node is determined based on geometry information of the neighbor node located at the same parent node as the current node.

In some embodiments, the at least one threshold is determined based on at least one of the following values:
a first value determined from the decoder;
a second value obtained through parsing from a parameter set or a code stream corresponding to the current node;
a third value determined based on first information and/or second information; or
a fourth value adaptively determined based on the first information and/or the second information.

The first information is configured for indicating a statistical characteristic or space information of the current node. The second information is configured for indicating a statistical characteristic of a decoded node.

To be specific, the first value may be a default value or a preset value of the decoder. The second value is a value obtained from a parameter set or a code stream corresponding to the current node. For example, the parameter set includes a sequence parameter set (SMS), a geometry parameter set (GPS), an attribute parameter set (APS), a geometry header brick (GHB), and an attribute header brick (AHB). For example, a value planarOccNumTh is obtained from the parameter set or the code stream, to determine the second value.

In some embodiments, the first information includes at least one type of the following information:
a number of reference nodes meeting a preset condition;
a number of child nodes of the reference nodes meeting the preset condition;
a number distribution of the child nodes of the reference nodes meeting the preset condition; or
a position relationship between the child nodes of the reference nodes meeting the preset condition and the to-be-decoded child node of the current node.

The preset condition is configured for indicating that the reference node is a high-plane node or a low-plane node.

The high-plane node is a node in which occupied child nodes are all in a high plane. The low-plane node is a node in which occupied child nodes are all in a low plane. Alternatively, the high-plane node satisfies that a number of occupied child nodes in a low plane is less than a number of first child nodes and a number of occupied child nodes in a high plane is greater than a number of second child nodes. The low-plane node satisfies that the number of occupied child nodes in the low plane is greater than a number of third child nodes and the number of occupied child nodes in the high plane is less than a number of fourth child nodes. The number of first child nodes, the number of second child nodes, the number of third child nodes, and the number of fourth child nodes are preset values.

In some embodiments, the second information includes at least one type of the following information:
a number of nodes satisfying a planar mode in the decoded node;
a number of reference nodes satisfying the planar mode in the decoded node;
a number of child nodes of the reference nodes satisfying the planar mode in the decoded node;
a ratio of the number of the reference nodes satisfying the planar mode in the decoded node to a number of non-null reference nodes; or
a ratio of the number of child nodes that are in the decoded node and that satisfy the reference node of the planar mode to the number of the reference nodes.

In some embodiments, the second information includes at least one type of the following information:
a number of reference nodes corresponding to nodes satisfying a planar mode in the decoded node;
a number of child nodes of the reference nodes corresponding to the nodes satisfying the planar mode in the decoded node;
a ratio of the number of the reference nodes corresponding to the nodes satisfying the planar mode in the decoded node to a number of non-null reference nodes corresponding to the nodes satisfying the planar mode; or
a ratio of the number of the child nodes of the reference nodes corresponding to the nodes satisfying the planar mode in the decoded node to the number of the reference nodes.

The third value is a value determined based on the first information and/or the second information. Alternatively, the third value may be determined based on another information. For example, the third value is determined by using a point cloud slice volume density (a ratio of a point cloud slice volume or area to a point number): determining a point cloud slice volume density Q₁ from the decoder, the parameter set, or the code stream, and in a case that the point cloud slice volume density is less than Q₁, determining that the third value is k₁; otherwise, determining that the third value is k₂.

The fourth value is a value determined in an adaptive mode based on the first information and/or the second information. The adaptive mode means that the fourth value is adjusted according to the obtained first information and/or second information.

In some embodiments, the fourth value is adjusted according to the first information. For example, if the number of reference nodes meeting a preset condition is greater than N₁, the fourth value a is adjusted to a=a+1. For another example, in a case that the number of child nodes of the reference node meeting the preset condition is less than N₂, the fourth value a is adjusted to a=a−1.

In some embodiments, spacing D₁ for statistically obtaining the second information is set. For every D₁ decoded nodes, the second information is statistically obtained. In some other embodiments, spacing D₂ for statistically obtaining the second information is set. For every D₂ decoded nodes, the second information of a non-null node is statistically obtained.

In some embodiments, before operation 440, a planar-eligible of the current node is determined. For example, the planar-eligible of the current node is determined based on the second node. After it is determined that the current node has the planar-eligible, determining of the geometry mode in operation 440 is performed.

For example, a planar-eligible of the current node is determined based on geometry information of a second node, where the planar-eligible is configured for indicating whether a planar mode is applicable to the current node. The second node is the same as or different from the first node. The second node is at least one of the following nodes: a reference node; a child node of the reference node; a decoded child node of the current node; or a to-be-decoded child node of the current node.

For example, the planar-eligible of the current node is determined based on a number of non-null nodes in the reference node. Alternatively, the planar-eligible of the current node is determined based on an occupancy status of the child node of the reference node. Alternatively, the planar-eligible of the current node is determined based on an occupancy status of the decoded child node of the reference node.

In conclusion, according to the method provided in this embodiment of this disclosure, a geometry mode of a current node is determined by obtaining geometry information provided by a first node corresponding to a current node. In combination with information in an octree partition process, the geometry mode of the current node is optimally determined, so that decoding may be performed according to an entropy decoding mode corresponding to the geometry mode, thereby improving efficiency of coding and decoding point cloud data.

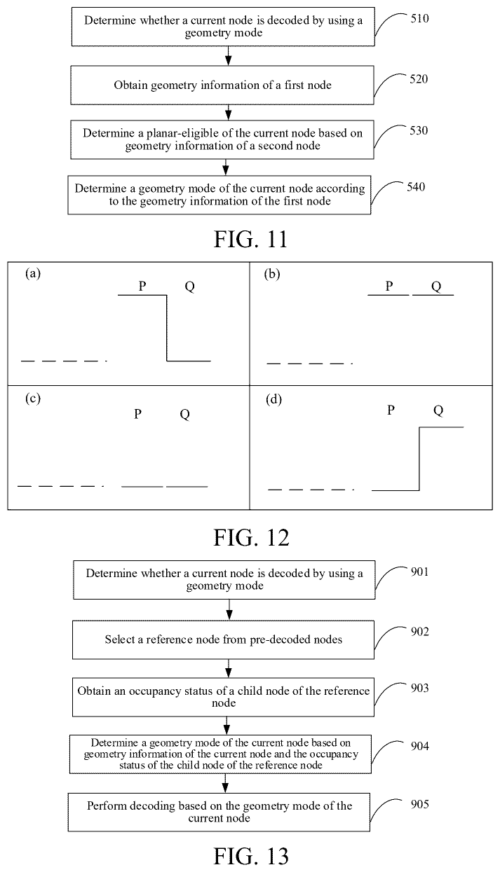

FIG. 11 shows a flowchart of a geometry mode determining method according to an embodiment of this disclosure. For ease of description, various operations are performed by only a computer device. The method is performed by a decoder/a decoder device/a computer device. The method may include all or some of the following operations 510, 520, 530, and 540.

### Operation 510: Determine Whether a Current Node is Decoded by Using a Geometry Mode

The current node is a node decoded currently.

The geometry mode decoding is configured for indicating a decoding mode in which entropy decoding is performed based on geometry information of a node. In the geometry mode decoding, different geometry modes use different entropy decoding modes.

In some embodiments, the determining whether the current node is decoded by using a geometry mode includes any one of the following operations: determining, at a point cloud or point cloud slice level, whether the current node is decoded by using the geometry mode; determining, at a macro block level, whether the current node is decoded by using the geometry mode; and determining, at a depth level of an octree, whether the current node is decoded by using the geometry mode.

In some embodiments, the determining whether the current node is decoded by using a geometry mode includes at least one of the following operations: determining, according to a decoding mode adopted by the decoder, whether the current node is decoded by using the geometry mode; determining, according to a parameter set or a code stream corresponding to the current node, whether the current node is decoded by using the geometry mode; or determining, according to a geometry mode threshold parameter, whether the current node is decoded by using the geometry mode, where the geometry mode threshold parameter is a threshold parameter obtained according to the decoder, the parameter set, or the code stream.

For example, the determining whether the current node is decoded by using a geometry mode includes at least one of the following modes:
a) Determine, at a point cloud or point cloud slice level, whether the current node is decoded by using the geometry mode:
   The decoder adopts a default decoding mode: Whether the current node is decoded by using the geometry mode is determined according to a decoding mode adopted by the decoder.
   Corresponding mode information is parsed from the parameter set or the code stream: For example, a parameter gsh_planar_mode in a geometry slice header information parameter set is configured for indicating enabling of a planar coding mode.
   The corresponding mode information is determined according to the geometry mode threshold parameter adopted by the decoder: For example, the geometry mode threshold parameter is a default threshold parameter of the point cloud slice density used by the decoder, and the corresponding mode information is determined according to the geometry mode threshold parameter.
   A corresponding geometry mode threshold parameter is parsed from the parameter set or the code stream, and corresponding mode information is determined: For example, a threshold parameter of a point cloud slice surface density is parsed from the parameter set or the code stream to serve as a geometry mode threshold parameter, and mode information corresponding to the current node is determined according to the geometry mode threshold parameter.
b) Determine, at a macro block (LCU) level, whether the current node is decoded by using the geometry mode:
   The decoder adopts a default decoding mode: Whether the current node is decoded by using the geometry mode is determined according to a decoding mode adopted by the decoder.
   Corresponding mode information is parsed from the parameter set or the code stream: Whether the current node is decoded by using the geometry mode is parsed in the parameter set or the code stream corresponding to the macro block.
   Corresponding mode information is determined according to a geometry mode threshold parameter adopted by the decoder (or a corresponding threshold parameter is parsed from the parameter set or the code stream): For example, the corresponding mode information is determined according to whether there is a prediction tree neighbor node during LCU partition. For another example, the corresponding mode information is determined according to the density during the LCU partition.
c) Determine, at a depth level of an octree, whether the current node is decoded by using the geometry mode:
   The decoder adopts a default decoding mode: Whether the current node is decoded by using the geometry mode is determined according to a decoding mode adopted by the decoder.
   Corresponding mode information is parsed from the parameter set or the code stream: Whether the current node is decoded by using the geometry mode is parsed in the parameter set or the code stream corresponding to the depth level of the octree.
   Corresponding mode information is determined according to a geometry mode threshold parameter adopted by the decoder (or a corresponding threshold parameter is parsed from the parameter set or the code stream): For example, if the geometry mode threshold parameter is point cloud bounding box information, corresponding mode information is determined according to the point cloud bounding box information (such as side length information) of the current layer node. For another example, if the geometry mode threshold parameter is a level threshold range, corresponding mode information is determined according to the level threshold range. When the current depth is less than d₁ and/or the depth is greater than d₂, planar mode determining is not performed, where d₁ and d₂ are values in the level threshold range.

This disclosure does not limit the scope and selection mode of the foregoing geometry mode threshold parameter for determining whether the current node is decoded by using the geometry mode.

The foregoing methods for determining whether the current node is decoded by using the geometry mode may be alternative for use, or may be combined for use. This is not limited in this disclosure. In some embodiments, operation 510 is also an alternative operation, and may be omitted.

### Operation 520: Obtain Geometry Information of a First Node

The current node is a node decoded currently.

The first node is a node providing information for determining a geometry mode of the current node. The first node is geometrically associated with the current node. The first node includes decoded information of historical nodes and/or neighborhood information of the current node. For example, the first node is a neighbor node of the current node. For another example, a target node is a pre-decoded node of the current node. For another example, the first node is a parent node of the current node, and so on.

In some embodiments, the first node is at least one of the following nodes:
a reference node;
a child node of the reference node;
a decoded child node of the current node; or
a to-be-decoded child node of the current node.

In some embodiments, the reference node is within a neighborhood of the current node. The reference information provided by the reference node is geometry information, neighborhood information, or space information of the current node.

The reference node includes at least one of the following nodes:
a) K₁ nodes are pre-decoded as reference nodes, including a parent node, where K₁ is a positive integer.
b) K₂ nodes of a same layer are pre-decoded as reference points (the same layer refers to a partition layer of the octree, not including a parent node), where K₂ is a positive integer.
c) K₃ reference nodes at a fixed position are selected from the decoded nodes: The fixed position is that the reference node is at a fixed relative position relative to the current node. K₃ is a positive integer.

In some embodiments, the reference node at the fixed position is obtained by setting an offset value offset in a coordinate axis direction. For example, in an xy direction, decoded nodes corresponding to (x-1, y, z), (x-2, y, z), (x, y-1, z), (x, y-2, z), and (x-1, y-1, z) are selected as reference nodes. This disclosure does not limit selection of the fixed position.

In some embodiments, one or more groups of offset values in the coordinate axis direction and possibly corresponding fixed multiples are set, where the fixed multiples may be selected according to information such as a quantization parameter. For example, in an XY direction, offset values along the X axis and the Y axis are separately m₃ and m₄, and corresponding fixed multiples are separately a and b. To be specific, nodes corresponding to (x-a*m₃, y, z) and (x, y-b*m₄, z) are selected as reference nodes.
d) K₄ non-null reference nodes at a fixed position are selected from the decoded nodes: The fixed position is that the reference node is at a fixed relative position relative to the current node. Non-null is that at least one child node of the node is occupied, where K₄ is a positive integer.

In some embodiments, an offset threshold is set. For example, in the XY direction, offset thresholds along the X axis and the Y axis are separately set to M₁ and M₂. In a case that the offset value m₁ in the X axis direction is less than M₁, (x-m₁, y, z) is selected as a reference node. In a case that the reference node is null, m₁=m₁+1. In a case that the offset value m₂ in the Y axis direction is less than M₂, (x, y-m₂, z) is selected as a reference node. In a case that the reference node is null, m₂=m₂+1. For another example, an offset threshold of a sum of offsets along the X axis and the Y axis is set to M₃. In a case that the sum of offset values m₁+m₂ is less than M₃, (x-m₁, y, z) and (x, y-m₂, z) are selected as reference nodes. In a case that (x-m₁, y, z) is null, m₁=m₁+1. In a case that (x, y-m₂, z) is null, m₂=m₂+1. The foregoing operations are repeated to obtain K₄ reference nodes, which are but not necessarily all non-null nodes. Alternatively, all obtained non-null reference nodes are selected.

In some embodiments, a number threshold is set. For example, if the number threshold is set to K₄, when the reference node selected by moving along a coordinate axis is null, an offset value along the coordinate axis is increased by one, and then the reference node is selected by using the foregoing method for setting an offset threshold. The foregoing operations are repeated until K₄ non-null reference nodes at a fixed position are obtained, and details are not described herein again.
e) A reference node is selected according to a situation of a parent node of a current node and/or a neighbor node of the parent node: For example, in a case that the current node is the only child node of the parent node of the current node, a range of selecting the reference node is expanded.

The foregoing modes of determining the reference node corresponding to the current node may be alternative for use, or may be combined for use. This is not limited in this disclosure.

### Operation 530: Determine a Planar-Eligible of the Current Node Based on Geometry Information of a Second Node

The planar-eligible is configured for indicating whether a planar mode is applicable to the current node, namely, whether the planar mode is available to the current node for decoding.

The second node is the same as or different from the first node. The second node is at least one of the following nodes:
a reference node;
a child node of the reference node;
a decoded child node of the current node; or
a to-be-decoded child node of the current node.

To be specific, a second node and a first node that are the same may be used. Alternatively, a first nodes and a second node that are different are obtained by using the same method. Alternatively, a first nodes and a second node that are different are obtained by using different methods. This is not limited in this disclosure.

For example, the planar-eligible of the current node is determined based on a number of non-null nodes in the reference node. Alternatively, the planar-eligible of the current node is determined based on an occupancy status of the child node of the reference node. Alternatively, the planar-eligible of the current node is determined based on an occupancy status of the decoded child node of the reference node.

The mode of determining a planar-eligible of the current node includes at least one of the following:
a) The decoder adopts a default decoding mode: determining the planar-eligible of the current node according to the decoding mode adopted by the decoder.
b) Corresponding mode information is parsed from a parameter set or a code stream: For example, the parameter set includes a parameter for indicating the planar-eligible of the current node.
c) The planar-eligible of the current node is determined according to a threshold parameter. The threshold parameter is a default threshold parameter adopted by the decoder, or a corresponding threshold parameter is parsed from the parameter set or the code stream corresponding to the current node.

The determining the planar-eligible of the current node according to the threshold parameter includes at least one of the following modes:
The planar-eligible of the current node is determined based on a number of non-null nodes in the reference node.

The number of non-null nodes in the reference node is compared with the threshold parameter, to determine the planar-eligible of the current node.
The planar-eligible of the current node is determined based on an occupancy status of the child node of the reference node.

In some embodiments, the planar-eligible of the current node is determined by comparing a number LowNode of reference nodes having all occupied child nodes in a low plane and/or a number HighNode of reference nodes having all occupied child nodes in a high plane with the threshold parameter.

In some other embodiments, the planar-eligible of the current node is determined by comparing a number LowNode of reference nodes in which a number of occupied child nodes in a low plane is greater than p₁ and a number of occupied child nodes in a high plane is less than p₂, and/or a number HighNode of reference nodes in which the number of occupied child nodes in the low plane is less than p₃ and the number of occupied child nodes in the high plane is greater than p₄ with the threshold parameter. p₁, p₂, p₃, and p₄ are configured for indicating a child node occupancy status threshold, and are all positive integers.
The planar-eligible of the current node is determined based on an occupancy status of the decoded child node of the reference node:

In some embodiments, the planar-eligible of the current node is determined by comparing the number LowOccNum of occupied child nodes in a low plane in LowNode, and/or the number HighOccNum of occupied child nodes located in a high plane in HighNode with the threshold parameter.

In some other embodiments, the planar-eligible of the current node is determined according to a ratio of LowOccNum to LowNode. Alternatively, the planar-eligible of the current node is determined according to a ratio of LowOccNum to the number of non-null reference nodes. Further alternatively, the planar-eligible of the current node is determined according to a ratio of HighOccNum to HighNode. Alternatively, the planar-eligible of the current node is determined according to a ratio of HighOccNum to the number of non-null reference nodes.

The foregoing modes of determining the planar-eligible of the current node may be alternative for use, or may be combined for use. This is not limited in this disclosure. In some embodiments, operation 530 is an alternative operation, and may be omitted.

### Operation 540: Determine a Geometry Mode of the Current Node according to the Geometry Information of the First node

The geometry mode is mode information corresponding to an entropy decoding mode. After the planar-eligible of the current node is determined in operation 530, a planar mode of the current node is determined in this operation, where different planar modes use different entropy decoding modes.
(a) Determine information about the decoded node, including at least one type of the following information:
   an occupancy status of a child node of the reference node;
   an occupancy status of a decoded child node of the current node;
   an occupancy status of a parent node of the current node; or
   child node information of a reference node located on a same parent node as the current node.

The occupancy status of the child node includes a number of child nodes in a low plane, a number of child nodes in a high plane, and the like. The occupancy status of the parent node includes a number of child nodes owned by the parent node, and the like.
(b) Obtain a determining threshold k. There may be one or more determining thresholds. Methods for obtaining different thresholds may be the same or different. The mode of obtaining a determining threshold includes at least one of the following:
   A default threshold of the decoder is used as a first value.
   A corresponding second value is parsed from a parameter set or a code stream.

For example, the second value is determined based on a parameter planarOccNumTh in the parameter set.
A corresponding threshold is parsed according to the default threshold of the decoder or from the parameter set or the code stream, and a third value is determined according to the first parameter and/or the second parameter.

For example, a threshold parameter Q₁ of a ratio (volume density) of a volume or an area of a point cloud slice to a point number is obtained through the decoder, the parameter set, or the code stream. In a case that the volume density of the point cloud slice is less than Q₁, it is determined that the third value is k₁. Otherwise, a third value k₂ is used.
A corresponding threshold is parsed according to the default threshold of the decoder or from the parameter set or the code stream, and a fourth value is determined in an adaptive mode according to the first parameter and/or the second parameter.

The adaptive mode refers to adjusting the fourth value according to information about the current node and/or the decoded node. To be specific, the fourth value is adjusted in a case that the current node and/or the decoded node satisfies a preset condition.

For example, a threshold parameter k₁ is obtained. A number of reference nodes of the current node obtained statistically is N₁, and a threshold of the reference node of the preset condition is thresN₁. In a case that N₁>thresN₁, it is determined that the fourth value is k₁=k₁+1. For another example, a threshold parameter k₂ is obtained. A number of child nodes of the reference node obtained statistically is N₂, and a threshold of the child nodes of the reference node of the preset condition is thresN₂. In a case that N₂<thresN₂, it is determined that the fourth value is k₂=k₂−1.

In some embodiments, the fourth value is obtained in an adaptive mode according to current node information. The current node information includes at least one of the following:
a number of reference nodes meeting a preset condition;
a number of child nodes of the reference nodes meeting the preset condition;
a number distribution of the child nodes of the reference nodes meeting the preset condition; or
a position relationship between the child nodes of the reference nodes meeting the preset condition and a current child node.

The preset condition is that the reference node satisfies a high-plane child node or a low-plane child node.

The number distribution of the child nodes is a position status of the child node distribution. For example, there are three reference nodes meeting the preset condition, and the number distribution of the child nodes is 4:1: 1, 2:2: 2, or the like.

In some other embodiments, the fourth value is obtained in an adaptive mode according to statistical characteristics of a pre-decoded node. For example, spacing M₁ is set. For every M₁ decoded nodes, a situation meeting the condition is statistically obtained, where the situation meeting the condition includes at least one of the following:
a number of decoded nodes satisfying a planar mode;
a number of reference nodes of the decoded nodes satisfying the planar mode;
a number of child nodes of the reference nodes of the decoded nodes satisfying the planar mode;
a ratio of a number of the reference nodes of the decoded nodes satisfying the planar mode to a number of non-null reference nodes; or
a ratio of a number of the child nodes of the reference nodes of the decoded nodes satisfying the planar mode to a number of reference nodes.

In some other embodiments, the fourth value is obtained in an adaptive mode according to statistical characteristics of a pre-decoded node. Spacing M₂ is set. For every M₂ decoded nodes, a non-null node meeting the condition is statistically obtained, where the situation meeting the condition includes at least one of the following:
a number of reference nodes corresponding to nodes satisfying a planar mode;
a number of child nodes of the reference nodes corresponding to the nodes satisfying the planar mode;
a ratio of the number of the reference nodes corresponding to the nodes satisfying the planar mode to a number of non-null reference nodes corresponding to the nodes satisfying the planar mode; or
a ratio of the number of the child nodes of the reference nodes corresponding to the nodes satisfying the planar mode to the number of the reference nodes.
(c) Determine a geometry mode of a current node according to the information about the reference node obtained in (a) and the determining threshold obtained in (b). The geometry mode of the current node is determined in any one or a combination of the following modes:
The geometry mode of the current node is determined according to child node statistics of the reference node:

In some embodiments, it is determined that the geometry mode of the current node is a first decoding mode in a case that the number of the low-plane occupancy child nodes is less than the first threshold and the number of the high-plane occupancy child nodes is greater than the second threshold. Alternatively, it is determined that the geometry mode of the current node is a second decoding mode in a case that the number of the low-plane occupancy child nodes is greater than the third threshold and the number of the high-plane occupancy child nodes is less than the fourth threshold.

For example, a first threshold k₁, a second threshold k₂, a third threshold k₃, and a fourth threshold k₄ are set. In a case that the number LowOccNum of low-plane occupancy child nodes is less than k₁ and the number HighOccNum of high-plane occupancy child nodes is greater than k₂, a mode A1 is entered. In a case that the number LowOccNum of low-plane occupancy child nodes is greater than k₃ and the number HighOccNum of high-plane occupancy child nodes is less than k₄, a mode B1 is entered.
The geometry mode of the current node is determined according to a position of a current to-be-decoded child node:
Child nodes in a same plane enter a same mode: For example, as shown in FIGS. 4, 0^{th}, 2^{nd}, 4^{th}, and 6^{th} child nodes in a low plane enter a same mode B2.
Some child nodes in a same plane enter a same mode: For example, as shown in FIG. 4, the 0^{th} and 2^{nd} child nodes in the low plane enter a mode B21, and the 4^{th} and 6^{th} child nodes enter a mode B22.
Child nodes in a same plane enter different modes.
Child nodes at different positions enter different modes.
Child nodes at particular positions enter different modes. For example, if the current to-be-decoded child node is the first child node (the 0^{th} child node), a mode A21 is entered. If the current to-be-decoded child node is the last child node (a 7^{th} child node), the mode B21 is entered. If the current to-be-decoded child node is another child node, a mode C21 is used.
The geometry mode of the current node is determined according to a position of a decoded child node of the current node:

Referring to FIG. 12, FIG. 12 shows a schematic diagram of determining a geometry mode of a current node according to a position of a decoded child node of the current node. A dashed line represents a plane in which a reference node is located, P represents a decoded node of the current node, and Q represents a to-be-decoded node of the current node.
A planar mode is not entered in a case that a current to-be-decoded child node has no decoded child node that is in a same plane.
A mode C1 is entered in a case that the decoded child node P is a jump point (the decoded child node P and the reference node are not in a same plane) and the to-be-decoded child node Q and the decoded node P are not in a same plane, as shown in FIG. 12(a).
A mode C2 is entered in a case that the decoded child node P is a jump point (the decoded child node P and the reference node are not in a same plane) and the to-be-decoded child node Q and the decoded node P are in a same plane, as shown in FIG. 12(b).
A mode C3 is entered in a case that the decoded child node P and the reference node are in a same plane and the to-be-decoded child node Q and the decoded node P are in a same plane, as shown in FIG. 12(c).
A mode C4 is entered in a case that the decoded child node P and the reference node are in a same plane and the to-be-decoded child node Q is a jump point (the to-be-decoded child node Q and the decoded node P are not in a same plane), as shown in FIG. 12(d).
The geometry mode of the current node is determined according to a determining threshold:

In some embodiments, in a case that the determining threshold is K₁, a mode A4 is entered. In a case that the determining threshold is K₂, a mode B4 is entered.
In a case that the reference node does not satisfy a planar mode and N₂ decoded child nodes of the current node are in a same plane, a child node that is also in the same plane is a mode E.

The foregoing conditions may be used alone or in combination. For example, the determining threshold K₁ is selected. In a case that LowOccNum<1 and HighOccNum>K₁, a mode A41 is entered. In a case that the current to-be-decoded child node is in a low plane, LowOccNum>K₁, and HighOccNum<1, a mode A42 is entered. For another example, the determining threshold K₂ is selected. In a case that LowOccNum<1 and HighOccNum>K₂, a mode B41 is entered. In a case that the current to-be-decoded child node is in the low plane, LowOccNum>K₂, and HighOccNum<1, a mode B42 is entered.
(d) After the geometry mode of the current node is determined, different decoding methods are used for a result of mode determining.

In some embodiments, in a case that the current to-be-decoded child node is the last child node and the pre-decoded child nodes are all null, the current child node occupancy code is 1, and parsing is not required.

In conclusion, according to the method provided in this embodiment of this disclosure, a geometry mode of a current node is determined by obtaining geometry information of a first node related to the current node. The geometry mode of the current node is optimally determined in combination with geometry information in an octree partition process, and historical node information and neighborhood information of the current node are used, so that decoding may be performed according to an entropy decoding mode corresponding to the geometry mode, thereby improving efficiency of coding and decoding point cloud data.

FIG. 13 shows a flowchart of a geometry mode determining method according to an embodiment of this disclosure. For ease of description, various operations are performed by only a computer device. The method is performed by a decoder/a decoder device/a computer device. The method may include all or some of the following operations 901, 902, 903, 904, and 905.

### Operation 901: Determine Whether a Current Node is Decoded by Using a Geometry Mode

The geometry mode includes at least one of the following: an isolated point mode and a planar mode.

For example, whether the current node is decoded by using the geometry mode is determined at a point cloud or point cloud slice level, a macro block level, or a depth level of an octree. For example, it is determined that a planar mode is enabled for a point cloud geometry slice in which a current slice is located. To be specific, a parameter for instructing to enable the planar mode is planarSlice=true.

### Operation 902: Select a Reference Node from Pre-Decoded Nodes

The operations of selecting the reference node are as follows:
1) Select, in an XY axis direction, nodes (x-1, y, z), (x, y-1, z), and (x-1, y-1, z) at fixed positions in the XY axis direction.
2) Statistically obtain a number k of non-null nodes. In a case that the number of non-null nodes in the foregoing three nodes is less than a threshold K₁, the reference node is determined in a preset order within a range of an X axis offset threshold xoffset and a Y axis offset threshold yoffset. For example, the preset order is represented in a form of an array of xOffset and yOffset as xOffset[ ]={1, 1, 0, 0, 1, 2, 2, 2, 3, 3, 3, 3, 2, 1, 0} and yOffset[ ]={0, 1,1, 2, 2, 2, 1, 0, 0, 1, 2, 3, 3, 3, 3}.

K₁, xoffset, and yoffset are preset parameters, or determined from the decoder or obtained by parsing from a parameter set or a code stream.
3) In a case that a corresponding decoded node (x-xoffset[i], y-yoffset[j], z) after the offset is a non-null node, k=k+1, where i is a positive integer less than the X axis offset threshold xoffset, and j is a positive integer less than the Y axis offset threshold yoffset.
4) Stop the operation in a case that the selected reference node is k=M₁, where M₁ is a number threshold of reference nodes. To be specific, in a case that the number of the selected reference nodes reaches the number threshold, no reference node continues to be selected.

### Operation 903: Obtain an Occupancy Status of a Child Node of the Reference Node

A number LowOccNum of low-plane occupied child nodes and a number HighOccNum of high-plane occupied child nodes of the reference node are statistically obtained.

### Operation 904: Determine a Geometry Mode of the Current Node Based on Geometry Information of the Current Node and the Occupancy Status of the Child Node of the Reference Node

For an i^{th} to-be-decoded child node of the current node, the coded occupancy code of the current node is codedOccupancy.

A mode A is entered when the to-be-decoded child node of the current node is in a low plane and there is no low-plane child node in the reference node and the decoded child node. A mode B is entered when the to-be-decoded child node of the current node is in a high plane and there is no high-plane child node in the reference node and the decoded child node.

### Operation 905: Perform Decoding Based on the Geometry Mode of the Current Node

Different context models contextModel are designed for the foregoing mode A and mode B, and an existing context model remains in another case. The context model corresponds to an entropy decoding mode, and the current node is decoded based on the context model.

In some embodiments, a context model index value ctxIdxInk of an occupancy code occupancy is determined. The context model index value is a sum of a context model offset address ctxIdxInc and an offset value ctx_offset. After the context model index value of the occupancy code is determined, the context model may be allocated to the current node. The context model corresponds to an entropy decoding mode, and the current node is decoded based on the context model.

First, an offset value ctx_offset of ctxIdxInc is determined according to the geometry information of the decoded node. The offset value includes three values: 0, 257, and 258. When a geometry slice planar mode identifier gsh_planar_mode is 1, the following operations are performed; otherwise, ctx_offset is 0 by default.

```
  if (LowOccNum > 1 && HighOccNum < 1 && !!(i & 1) &&
(!(codedOccupancyCode & 0xaa)))
    ctx_offset = 257
  else if (LowOccNum < 1 && HighOccNum > 1 &&(!(i & 1)) &&
(!(codedOccupancyCode & 0x55)))
    ctx_offset = 258
  else ctx_offset = 0
```

where codedOccupancyCode represents a decoded child node of the current node. LowOccNum represents the number of low-plane occupied child nodes in child nodes of a neighbor node of the current node. HighOccNum represents the number of high-plane occupied child nodes in the child nodes of the neighbor node of the current node. The two variables are obtained by decoding a next part of occupancy code.

In some embodiments, the occupancy code is decoded, to determine LowOccNum and HighOccNum. LowOccNum represents the number of low-plane occupied child nodes in child nodes of a neighbor node of the current node. HighOccNum represents the number of high-plane occupied child nodes in the child nodes of the neighbor node of the current node.

Two variables LowOccNum and HighOccNum are initialized to 0. LowOccNum represents the number of low-plane occupied child nodes in the neighbor node of the current node. HighOccNum represents the number of high-plane occupied child nodes in the neighbor node of the current node. When the geometry slice planar mode identifier gsh_planar_mode is 1, the following operations are performed for a child node numbered as childIdx. Otherwise, LowOccNum and HighOccNum are directly 0:

```
  preNodePlanarNum = 0;
  xOffset = {1, 1, 0, 0, 1, 2, 2, 2, 3, 3, 3, 3, 2, 1, 0};
  yOffset = {0, 1, 1, 2, 2, 2, 1, 0, 0, 1, 2, 3, 3, 3, 3};
  while((k < 15) && (preNodePlanarNum <=5)){
            neighborOccupancyCode=GeometryNodeOccupancyCode[depth][xC−
xOffset[k]][yC−yOffset [k]][zC ]
        if(!neighborOccupancyCode){
              preNodePlanarNum++;
              planarNodeOffset[preNodePlanarNum][0] = xOffset[k];
                planarNodeOffset[preNodePlanarNum][1] = yOffset[k];
        }
  }
  xC = (xN << !(partitionSkip & 4)) + ( childIdx & 4 == 1 );
  yC = (yN << !(partitionSkip & 2)) + ( childIdx & 2 == 1 );
  zC = (zN << !(partitionSkip & 1)) + ( childIdx & 1 == 1 );
  for(j = 0; j < 5; j ++){
        neighborOccupancyCode=GeometryNodeOccupancyCode[depth][xC−
planarNodeOffset[j][0]][yC − planarNodeOffset[j][1]] [zC]
      neighborOccupancyLowCode = neighborOccupancyCode & 0x55
      neighborOccupancyHighCode = neighborOccupancyCode & 0xaa
    for(i = 0; i < 8; i++){
          LowOccNum += (neighborOccupancyLowCode >> i ) & 1
          HighOccNum += (neighborOccupancyHighCode >> i ) & 1
      }
  }
```

where preNodePlanarNum represents the number of reference nodes meeting a preset condition, xOffset is an offset in an X axis, yOffset is an offset in a Y axis, neighborOccupancyCode represents a reference node occupancy code, GeometryNodeOccupancyCode represents a geometry occupancy code mapping table, planarNodeOffset represents an offset value meeting a condition, neighborOccupancyLowCode represents a low-plane occupancy code in the reference node, and neighborOccupancyHighCode represents a high-plane occupancy code in the reference node.
where partitionSkip is a geometry partition type identifier, is formed by a 3-bit unsigned integer, and represents that the partition type of the current node is an octree, a quadtree, or a binary tree. Three bits, from a high-order bit to a low-order bit, separately represent whether partition in the x, y, and z directions is to be skipped, where bit ‘0’ represents that partition is not to be skipped, and bit ‘1’ represents that partition is to be skipped.

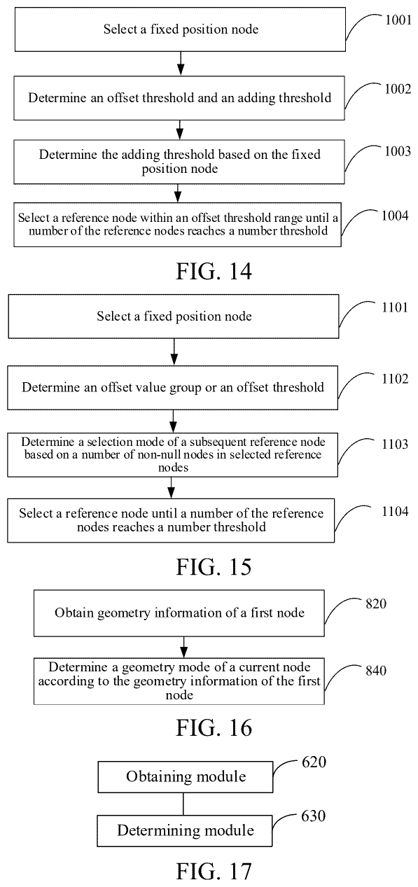

FIG. 14 shows a flowchart of a reference node selecting method according to an embodiment of this disclosure. For ease of description, various operations are performed by only a computer device. The method is performed by a decoder/a decoder device/a computer device. The method may include all or some of the following operations 1001, 1002, 1003, and 1004.

### Operation 1001: Select a Fixed Position Node

For example, in an XY axis direction, nodes (x-1, y, z), (x, y-1, z), and (x-1, y-1, z) at fixed positions are selected.

### Operation 1002: Determine an Offset Threshold and an Adding Threshold

The offset threshold is a value that is offset in a coordinate axis direction, and the adding threshold is a value that adds the foregoing offset threshold.

For example, an offset threshold xoffset in the X axis direction and an offset threshold yoffset in the Y axis direction are determined. An adding threshold addXoffset in the X axis direction and an adding threshold addYoffset in the Y axis direction are determined. The offset threshold is configured for indicating a maximum offset threshold in the coordinate axis direction. The adding threshold is configured for expanding a selection range of a reference node when there are many null nodes (for example, a number of null nodes is greater than a set null node number threshold). For example, offset thresholds xoffset and yoffset, and initial values addXOffset=k₁ and addYOffset=k₂ of the adding thresholds are determined, where values of k₁ and k₂ may be default values, or may be determined according to a size of a current geometry slice or an XY value of a current node.

### Operation 1003: Determine the Adding Threshold Based on the Fixed Position Node

For example, in a case that a node (x-1, y, z) is non-null, it is determined that the adding threshold is addXOffset=k₃. In a case that a node (x, y-1, z) is non-null, it is determined that the adding threshold is addYOffset=k₄. In a case that (x-1, y-1, z) is non-null, it is determined that the adding threshold is addXOffset=k₅ or addYOffset=k₆. In an implementation example, k₁=2, k₂=2, k₃=0, k₄=0, k₅=0, and k₆=0.

### Operation 1004: Select a Reference Node within an Offset Threshold Range until a Number of the Reference Nodes Reaches a Number Threshold

For example, the reference node is determined in a particular order within a range of offset thresholds xoffset and yoffset, for example, according to a Hilbert order, a linear order, a Morton order, a preset order, a default order, or the like.

In a case that the selected node (x-xoffset[i]-addXOffset, y-yoffset[j]-addYOffset, z) is non-null, the number of the selected reference nodes is k=k+1.

A number threshold M₂ is set. In a case that the number of the selected reference nodes is k=M₂, selection of the reference node is ended.

FIG. 15 shows a flowchart of a reference node selecting method according to an embodiment of this disclosure. For ease of description, various operations are performed by only a computer device. The method is performed by a decoder/a decoder device/a computer device. The method may include all or some of the following operations 1101, 1102, 1103, and 1104.

### Operation 1101: Select a Fixed Position Node

For example, in an XY axis direction, nodes (x-1, y, z), (x, y-1, z), and (x-1, y-1, z) at fixed positions are selected.

### Operation 1102: Determine an Offset Value Group or an Offset Threshold

For example, an offset value group xoffset in the X axis direction and an offset value group yoffset in the Y axis direction are determined. Alternatively, an offset threshold xoffset in the X axis direction and an offset threshold yoffset in the Y axis direction are determined. The offset value group is configured for indicating an order of selecting a reference node by offset. The offset threshold is configured for indicating a maximum offset range in a coordinate axis direction.

Values of xoffset and yoffset may be default values, or determined by using a size value in the XY axis direction of a current geometry slice.

### Operation 1103: Determine a Selection Mode of a Subsequent Reference Node Based on a Number of Non-Null Nodes in Selected Reference Nodes

The selection mode of the subsequent reference node is determined based on the number of non-null nodes in the selected reference nodes. Alternatively, the selection mode of the subsequent reference node is determined based on a number interval within which the number of non-null nodes in the selected reference nodes falls. Alternatively, the selection mode of the subsequent reference node is determined based on at least one threshold and the number of non-null nodes in the selected reference nodes.

For example, a number k of non-null nodes in the selected reference nodes is statistically obtained. In a case that k=0, searching for the subsequent reference node is not continued. The reference node is determined within the offset value groups or the offset thresholds xoffset and yoffset in a default order in a case that k<3. Another reference node at a fixed position is used, for example, (x-2, y, z) in a case that k=3.

### Operation 1104: Select a Reference Node until a Number of the Reference Nodes Reaches a Number Threshold

The reference node is selected according to the subsequent reference node selection mode determined in operation 1103.

In a case that the selected node (x-xoffset[i]-addXOffset, y-yoffset[j]-addYOffset, z) is non-null, the number of the selected reference nodes is k=k+1.

A number threshold M₂ is set. In a case that the number of the selected reference nodes is k=M₂, selection of the reference node is ended.

FIG. 16 shows a flowchart of a geometry mode determining method according to an embodiment of this disclosure. For ease of description, various operations are performed by only a computer device. The method is performed by a coder/a coder device/a computer device. The method may include all or some of the following operations 820 and 840.

### Operation 820: Obtain Geometry Information of a First Node

The current node is a node coded currently.

The first node is a node providing information for determining a geometry mode of the current node. The first node is geometrically associated with the current node. The first node includes coded information of historical nodes and/or neighborhood information of the current node. For example, the first node is a neighbor node of the current node. For another example, the first node is a pre-coded node of the current node. For another example, the first node is a parent node of the current node, and so on.

In some embodiments, the first node is at least one of the following nodes:
a reference node;
a child node of the reference node;
a coded child node of the current node; or
a to-be-coded child node of the current node.

In some embodiments, the reference node is selected from at least one of the following nodes:
a coded node;
a non-null coded node;
a coded node on a same layer as the current node;
a non-null coded node on a same layer as the current node;
a coded node at a fixed position;
a non-null coded node at a fixed position;
a parent node of the current node;
a neighbor node located at a same parent node as the current node; or
a child node of the neighbor node located at the same parent node as the current node.

The coded node is a pre-coded node, and includes the parent node of the current node. The non-null coded node is a pre-coded node including at least one occupied child node. The coded node on the same layer as the current node is a coded node that is on the same layer as the current node in octree partition, namely does not include the parent node of the current node. The non-null coded node on the same layer as the current node is a coded node that is on the same layer as the current node in octree partition and has at least one child node occupied. The coded node at the fixed position is a coded node that is at a fixed position relative to the current node. The non-null coded node at the fixed position is a coded node that is at a fixed position relative to the current node and has at least one child node occupied. The fixed position may be understood as a fixed offset position, a specified position, or the like.

In some embodiments, the coded node at the fixed position is obtained by setting a preset quantity of an offset. The coded node at the fixed position includes at least one of the following (an example in which coordinates of the current node are (x, y, z) is used):
a coded node corresponding to the current node being offset by a first preset quantity in a direction of a first coordinate axis, where the first preset quantity is a preset offset quantity of the offset in the direction of the first coordinate axis, and in an example in which the first coordinate axis is an X axis, if the first preset quantity is set to -1 or -2, the reference node is (x-1, y, z) or (x-2, y, z);
a coded node corresponding to the current node being offset by a second preset quantity in a direction of a second coordinate axis, where the second preset quantity is a preset offset quantity of the offset in the direction of the second coordinate axis, and in an example in which the second coordinate axis is a Y axis, if the second preset quantity is set to -1 or -2, the reference node is (x, y-1, z) or (x, y-2, z); or
a coded node corresponding to the current node being offset by a third preset quantity in the direction of the first coordinate axis and offset by a fourth preset quantity in the direction of the second coordinate axis, where the third preset quantity is a preset offset quantity of the offset in the direction of the first coordinate axis, the fourth preset quantity is a preset offset quantity of the offset in the direction of the second coordinate axis, and in an example in which the first coordinate axis is an X axis and the second coordinate axis is a Y axis, if the third preset quantity is set to -1 and the fourth preset quantity is set to -1, the reference node is (x-1, y-1, z).

The first coordinate axis and the second coordinate axis are coordinate axes in two different directions in a three-dimensional coordinate system.

In some embodiments, at least one of the first preset quantity, the second preset quantity, the third preset quantity, and the fourth preset quantity is:
a default value or value group;
a corresponding value or value group when a second condition is met;
determined based on the met second condition; or
determined according to at least one type of information.

The default value or value group may be preset. The second condition and the at least one type of information are described in detail in the following embodiments.

In some embodiments, at least one of the first preset quantity, the second preset quantity, the third preset quantity, and the fourth preset quantity varies based on a corresponding offset value variation, where the offset value variation is:
a default value or value group;
a corresponding value or value group when a second condition is met;
determined based on the met second condition; or
determined according to at least one type of information.

For example, when the number of non-null nodes in the decoded node is relatively large, a relatively large offset value variation is selected, so that an offset range can be expanded, to obtain more non-null nodes.

For another example, an offset threshold xoffset in the X axis direction is determined, and an offset value variation addXoffset in the X axis direction is determined. Three fixed position nodes are selected. In a case that there are two null nodes in the selected fixed position nodes, addXoffset=2. In a case that there is one null node in the selected fixed position nodes, addXoffset=1. In a case that there is no null node in the selected fixed position nodes, addXoffset=0. The preset quantity is a sum of the offset threshold xoffset and the offset value variation addXoffset. To be specific, in a case that there are many null nodes, the preset quantity varies largely based on the offset value variation. In a case that there are few null nodes, the preset quantity varies less based on the offset value variation.

In some embodiments, at least one of the direction of the first coordinate axis and the direction of the second coordinate axis is:
a default coordinate axis direction;
a corresponding coordinate axis direction when a second condition is met;
determined based on the met second condition; or
determined according to at least one type of information.

The default coordinate axis direction may be preset. The second condition and the at least one type of information are described in detail in the following embodiments.

The second condition is related to at least one type of the following information:
geometry slice information (for example, a geometry slice density or a size of a point cloud bounding box);
a relative position of the current node;
occupancy information of a parent node of the current node;
occupancy information of a neighbor node of the current node; or
occupancy information of the first k reference nodes.

The geometry slices are different geometric figures, for example, a square, a rectangle, and a circle. k may be a preset value. The relative position of the current node is information about a position of the current node relative to another node/parent node/neighbor node/reference node. The relative position of the current node may be described by using at least one of coordinates of the current node, a layer on which the current node is located, and a code. The occupancy information is information about an occupied position. For example, the occupancy information of the parent node of the current node is information about a position occupied by the parent node of the current node, and may specifically include at least one of coordinates of the current node, a layer on which the parent node of the current node is located, and a code.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

The data geometry precision may be described by using a geometry precision such as a plane position, a height, a shape, or a ratio of data.

The foregoing preset quantities and coordinate axis directions may be all default values or preset values, or partially default values and partially determined based on a second condition or related information, or all determined based on the related information, or the like. To be specific, any one of the foregoing modes of selecting the preset quantities and the coordinate axes may be selected, or a combination thereof may be used.

For example, a default value group is used as a preset quantity. For another example, the second condition is configured for indicating a parameter Q₁ of the geometry slice density. In a case that the current geometry slice density is greater than Q₁, a corresponding value k₁ is selected. Otherwise, a value k₂ is selected. For another example, there are a plurality of candidate values or a plurality of groups of candidate values meeting the second condition, and one candidate value or one group of candidate values is selected as a preset quantity. For another example, the preset quantity is determined according to the geometry slice information. In a case that the geometry slice density is relatively small, the preset quantity is increased. For another example, in a case that the current node is the only child node of the parent node, the preset quantity is increased. For another example, in a case that the neighbor node of the parent node of the current node is null, the preset quantity is increased, and the like. The mode of selecting the preset quantities and selecting the coordinate axes is not limited in this disclosure.

In some embodiments, the coded node at the fixed position is obtained by setting a preset quantity of an offset and a fixed multiple. For example, a product of the preset quantity of the offset and the fixed multiple is an actually used offset. The coded node at the fixed position includes at least one of the following (an example in which coordinates of the current node are (x, y, z) is used):
a coded node corresponding to the current node being offset by a first preset multiple offset in a direction of a first coordinate axis, where the first multiple offset is an offset obtained by multiplying a first preset quantity by a first multiple, the first preset quantity is a preset offset quantity of the offset in the direction of the first coordinate axis, and in an example in which the first coordinate axis is an X axis, if the first preset quantity is set to -1 or -2 and the first multiple is set to 2, the reference node is (x-2, y, z) or (x-4, y, z);
a coded node corresponding to the current node being offset by a second preset multiple offset in a direction of a second coordinate axis, where the second multiple offset is an offset obtained by multiplying a second preset quantity by a second multiple, the second preset quantity is a preset offset quantity of the offset in the direction of the second coordinate axis, and in an example in which the second coordinate axis is a Y axis, if the second preset quantity is set to -1 or -2 and the second multiple is set to 4, the reference node is (x, y-4, z) or (x, y-8, z); or
a coded node corresponding to the current node being offset by a third multiple offset in the direction of the first coordinate axis and offset by a fourth multiple offset in the direction of the second coordinate axis, where the third multiple offset is an offset obtained by multiplying a third preset quantity by a third multiple, the fourth multiple offset is an offset obtained by multiplying a fourth preset quantity by a fourth multiple, the third preset quantity is a preset offset quantity of the offset in the direction of the first coordinate axis, the fourth preset quantity is a preset offset quantity of the offset in the direction of the second coordinate axis, and in an example in which the first coordinate axis is an X axis and the second coordinate axis is a Y axis, if the first preset quantity is set to m₃, the second preset quantity is set to m₄, and the third multiple and the fourth multiple are set to 1, the reference node is (x-m₃, y-m₄, z).

The first coordinate axis and the second coordinate axis are coordinate axes in two different directions in a three-dimensional coordinate system. The first multiple, the second multiple, the third multiple, and the fourth multiple are preset fixed multiples, and may be selected according to an actual situation. For example, the fixed multiple is selected based on a quantization parameter of the point cloud.

In some embodiments, at least one of the first preset quantity, the second preset quantity, the third preset quantity, the fourth preset quantity, the first multiple, the second multiple, the third multiple, and the fourth multiple is:
a default value or value group;
a corresponding value or value group when a second condition is met;
selected from a plurality of candidate values based on the met second condition; or
determined according to at least one type of information.

The default value or value group may be preset. The second condition and the at least one type of information are described in detail in the following embodiments.

In some embodiments, at least one of the direction of the first coordinate axis and the direction of the second coordinate axis is:
a default value or value group;
a corresponding value or value group when a second condition is met;
determined based on the met second condition; or
determined according to at least one type of information.

The second condition is related to at least one type of the following information:
geometry slice information;
a relative position of the current node;
occupancy information of a parent node of the current node;
occupancy information of a neighbor node of the current node; or
occupancy information of the first k reference nodes.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

In some embodiments, the coded node at the fixed position is obtained by setting an offset threshold. The coded node at the fixed position includes at least one of the following (an example in which coordinates of the current node are (x, y, z) is used):
a coded node corresponding to an offset of the current node in the direction of the first coordinate axis being less than a first offset threshold, where the first offset threshold is a preset maximum offset quantity of the offset in the direction of the first coordinate axis, and in an example in which the first coordinate axis is an X axis, if the first offset threshold is set to M₁, the reference node is (x-m₁, y, z), where m₁<M₁;
a coded node corresponding to an offset of the current node in the direction of the second coordinate axis being less than a second offset threshold, where the second offset threshold is a preset maximum offset quantity of the offset in the direction of the second coordinate axis, and in an example in which the second coordinate axis is a Y axis, if the second offset threshold is set to M₂, the reference node is (x, y-m₂, z), where m₂<M₂; or
a coded node corresponding to a sum of the offset of the current node in the direction of the first coordinate axis and the offset in the direction of the second coordinate axis being less than a third offset threshold, where the third offset threshold is a preset maximum sum of the offset quantities of the offsets in the direction of the second coordinate axis and in the direction of the second coordinate axis, and in an example in which the first coordinate axis is an X axis and the second coordinate axis is a Y axis, if the third offset threshold is set to M₃, the reference node is (x-m₁, y-m₂, z), where m₁+m₂<M₃.

The first coordinate axis and the second coordinate axis are coordinate axes in two different directions in a three-dimensional coordinate system.

The first offset threshold, the second offset threshold, the third offset threshold, the fourth offset threshold, the direction of the first coordinate axis, and the direction of the second coordinate axis are determined according to at least one type of the following information: a quantization parameter; a data geometry precision; a geometry slice density; a geometry slice size; a relative position of the current node; or a parent node and a neighbor node of the current node.

In some embodiments, at least one of the first offset threshold, the second offset threshold, the third offset threshold, and the fourth offset threshold is:
a default value or value group;
a corresponding value or value group when a second condition is met;
determined based on the met second condition; or
determined according to at least one type of information.

In some embodiments, at least one of the direction of the first coordinate axis and the direction of the second coordinate axis is:
a default coordinate axis direction;
a corresponding coordinate axis direction when a second condition is met;
determined based on the met second condition; or
determined according to at least one type of information.

The second condition is related to at least one type of the following information:
geometry slice information;
a relative position of the current node;
occupancy information of a parent node of the current node;
occupancy information of a neighbor node of the current node; or
occupancy information of the first k reference nodes.

The geometry slices are different geometric figures, for example, a square, a rectangle, and a circle. k may be a preset value. The relative position of the current node is information about a position of the current node relative to another node/parent node/neighbor node/reference node. The relative position of the current node may be described by using at least one of coordinates of the current node, a layer on which the current node is located, and a code. The occupancy information is information about an occupied position. For example, the occupancy information of the parent node of the current node is information about a position occupied by the parent node of the current node, and may specifically include at least one of coordinates of the current node, a layer on which the parent node of the current node is located, and a code.

The at least one type of information includes at least one type of the following information:
a quantization parameter;
a data geometry precision;
a geometry slice density;
a geometry slice size;
occupancy information of the reference node;
a relative position of the current node; or
a parent node and a neighbor node of the current node.

The data geometry precision may be described by using a geometry precision such as a plane position, a height, a shape, or a ratio of data.

In some embodiments, the coded node at the fixed position is obtained by setting an offset threshold, and a number threshold is set for a number of selected coded nodes. The number threshold may be a fixed number. The coded node is selected based on a preset order until a fixed number of coded nodes are selected.

In some embodiments, the coded node at the fixed position is selected by: selecting, in a first order, a fixed number of coded nodes meeting a first condition, where the first order is one of a preset order, a default order, a linear order, a Hilbert order, a Morton order, or a coordinate axis order. The first condition is a preset condition. For example, the node is a non-null node.

In some embodiments, a fixed number of coded nodes meeting a selection condition are selected in a first order from the coded node corresponding to an offset of the current node in the direction of the first coordinate axis being less than a first offset. A fixed number of coded nodes meeting a selection condition are selected in a second order from the coded node corresponding to an offset of the current node in the direction of the second coordinate axis being less than a second offset. A fixed number of coded nodes meeting a selection condition are selected in a third order from the coded node corresponding to a sum of the offset of the current node in the direction of the first coordinate axis and the offset in the direction of the second coordinate axis being less than a third offset. The first order is one of a preset order, a default order, a linear order, a Hilbert order, a Morton order, or a coordinate axis order. The second order is one of a preset order, a default order, a linear order, a Hilbert order, a Morton order, or a coordinate axis order. The third order is one of a preset order, a default order, a linear order, a Hilbert order, a Morton order, or a coordinate axis order. The first offset is at least one offset less than a first offset threshold. The second offset is at least one offset less than a second offset threshold. The third offset is at least one offset less than a third offset threshold.

In some other embodiments, a fixed number of coded nodes meeting a selection condition are selected in a first order from the coded node corresponding to an offset of the current node in the direction of the first coordinate axis being less than a first offset threshold. A fixed number of coded nodes meeting a selection condition are selected in a second order from the coded node corresponding to an offset of the current node in the direction of the second coordinate axis being less than a second offset threshold. A fixed number of coded nodes meeting a selection condition are selected in a third order from the coded node corresponding to a sum of the offset of the current node in the direction of the first coordinate axis and the offset in the direction of the second coordinate axis being less than a third offset threshold. The first order is one of a preset order, a default order, a linear order, a Hilbert order, a Morton order, or a coordinate axis order. The second order is one of a preset order, a default order, a linear order, a Hilbert order, a Morton order, or a coordinate axis order. The third order is one of a preset order, a default order, a linear order, a Hilbert order, a Morton order, or a coordinate axis order.

The preset order is a preset selection order of nodes at fixed positions. The default order is an order determined from a coder or obtained by parsing a parameter set or a code stream corresponding to the current node. The coordinate axis order is an order of sequential or alternate selection according to the coordinate axes. The linear order, the Hilbert order, or the Morton order is shown with reference to FIG. 10. FIG. 10 shows a schematic diagram of an order of selecting a coded node at a fixed position according to an embodiment of this disclosure.

Part (a) of FIG. 10 shows a schematic diagram of a Hilbert order in an X axis direction. FIG. (a) shows that in a case that an offset threshold in an X axis and an offset threshold in a Y axis are both 4, there are 16 alternative coded nodes at fixed positions, namely, (x, y), (x-1, y), (x-1, y-1), (x, y-1), (x, y-2), (x-1, y-2), (x-2, y-2), (x-2, y-1), (x-2, y), (x-3, y), (x-3, y-1), (x-3, y-2), (x-3, y-3), (x-2, y-3), (x-1, y-3), and (x, y-3). If the number threshold is a value less than 16, sequential selection is performed according to a direction of an arrow in FIG. (a), until a fixed number of coded nodes are selected. For example, in a case that the number threshold is 3 and the fixed number of selected nodes is also 3, (x, y), (x-1, y), and (x-1, y-1) are sequentially selected as coded nodes at fixed positions.

Part (b) of FIG. 10 shows a schematic diagram of a morton/zigzag order in an X axis direction. FIG. (b) shows that in a case that an offset threshold in an X axis and an offset threshold in a Y axis are both 4, there are 16 alternative coded nodes at fixed positions, namely, (x, y), (x-1, y), (x, y-1), (x-1, y-1), (x, y-2), (x-1, y-2), (x, y-3), (x-1, y-3), (x-2, y), (x-3, y), (x-2, y-1), (x-3, y-1), (x-2, y-2), (x-3, y-2), (x-2, y-3), and (x-3, y-3). If the number threshold is a value less than 16, sequential selection is performed according to a direction of an arrow in FIG. (b), until a fixed number of coded nodes are selected. For example, in a case that the number threshold is 4 and the fixed number of selected nodes is also 4, (x, y), (x-1, y), (x, y-1), and (x-1, y-1) are sequentially selected as coded nodes at fixed positions.

Part (c) of FIG. 10 shows a schematic diagram of a linear order in an X axis direction. FIG. (c) shows that in a case that an offset threshold in an X axis and an offset threshold in a Y axis are both 4, there are 16 alternative coded nodes at fixed positions, namely, (x, y), (x-1, y), (x-2, y), (x-3, y), (x, y-1), (x-1, y-1), (x-2, y-1), (x-3, y-1), (x, y-2), (x-1, y-2), (x-2, y-2), (x-3, y-2), (x, y-3), (x-1, y-3), (x-2, y-3), and (x-3, y-3). If the number threshold is a value less than 16, sequential selection is performed according to a direction of an arrow in FIG. (c), until a fixed number of coded nodes are selected. For example, in a case that the number threshold is 5 and the fixed number of selected nodes is also 5, (x, y), (x-1, y), (x-2, y), (x-3, y), and (x, y-1) are sequentially selected as coded nodes at fixed positions.

The mode of selecting a coded node at a fixed position is not limited to the foregoing mode. This is not limited in this disclosure.

The non-null coded node at the fixed position is a node that has at least one child node occupied in the foregoing coded node at the fixed position. The non-null coded node at the fixed position may be obtained in at least one of the following modes (an example in which coordinates of the current node are (x, y, z) is used):
After the coded node at the fixed position is obtained by using the foregoing method, a non-null coded node is selected therefrom. For example, all coded nodes at fixed positions are obtained within the range of an offset threshold, and all non-null nodes are selected therefrom.
A coded node at a fixed position is selected based on the foregoing method for setting an offset threshold. In a case that the coded node at the fixed position is a null node, an offset of thereof along a coordinate axis is increased by one. For example, if an offset threshold in an X axis direction is set to M₁, the node is (x-m₁, y, z), where m₁<M₁. If (x-m₁, y, z) is a null node, m₁=m₁+1. For another example, if an offset threshold in a Y axis direction is set to M₂, the reference node is (x, y-m₂, z), where m₂<M₂. If (x, y-m₂, z) is a null node, m₂=m₂+1.
A number threshold is set. A coded node at a fixed position is selected based on the foregoing method for setting an offset threshold. In a case that the coded node at the fixed position is a null node, an offset of thereof along a coordinate axis is increased by one, until a number of non-null coded nodes at a fixed position reaches the number threshold.

In some embodiments, a fixed number of coded nodes meeting a first condition are selected in a first order, until a fixed number (a number threshold) of coded nodes are selected. The first order may be any one of a default order, a preset order, a Hilbert order, a Morton order, a linear order, and a coordinate axis order. The first condition is that the node is non-null.

In some embodiments, before operation 820, whether the current node is coded by using a geometry mode is determined. In a case that the current node is coded by using the geometry mode, operation 820 and operation 840 are performed.

### Operation 840: Determine a Geometry Mode of the Current Node according to the Geometry Information of the First Node

The geometry mode is mode information corresponding to an entropy coding mode. A geometry mode of point cloud data includes an isolated point mode, a planar mode, and the like. The isolated point mode is configured for coding and/or decoding a node determined as an isolated point. The planar mode is configured for coding and/or decoding a planar mode node. Schematically, the planar mode is that reference nodes of the current node are located in a same plane, coded child nodes of the current node are located in a same plane, or the like.

For example, it is determined that the geometry mode of the current node is a target coding mode based on the geometry information of the first node. The target coding mode is a coding mode corresponding to the planar mode node.

The geometry mode of the current node is determined according to an occupancy status of the first node in a case that the first node includes a child node of the reference node. The geometry mode of the current node is determined according to a plane position of the first node in a case that the first node includes a coded child node of the current node.

The geometry mode of the current node is determined based on the geometry information of the first node. Alternatively, the geometry mode of the current node is determined based on at least one threshold and the geometry information of the first node. To be specific, the geometry mode of the current node may be determined by using only the geometry information of the first node. Alternatively, the geometry information of the first node may be compared with at least one threshold with reference to an obtained threshold and the geometry information of the first node (for example, a child node of the reference node), to determine the geometry mode of the current node.

In some embodiments, it is determined that the current node is a first coding mode in a case that the number of the low-plane occupancy child nodes is less than the first threshold and the number of the high-plane occupancy child nodes is greater than the second threshold. Alternatively, it is determined that the current node is a second coding mode in a case that the number of the low-plane occupancy child nodes is greater than the third threshold and the number of the high-plane occupancy child nodes is less than the fourth threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node.

The high-plane node is a node in which occupied child nodes are all in a high plane. The low-plane node is a node in which occupied child nodes are all in a low plane. Alternatively, the high-plane node satisfies that a number of occupied child nodes in a low plane is less than a number of first child nodes and a number of occupied child nodes in a high plane is greater than a number of second child nodes. The low-plane node satisfies that the number of occupied child nodes in the low plane is greater than a number of third child nodes and the number of occupied child nodes in the high plane is less than a number of fourth child nodes. The number of first child nodes, the number of second child nodes, the number of third child nodes, and the number of fourth child nodes are preset values.

For example, a first threshold k₁, a second threshold k₂, a third threshold k₃, and a fourth threshold k₄ are set. A low-plane occupancy child node LowOccNum and a high-plane occupancy child node HighOccNum are statistically obtained. In a case that LowOccNum<k₁ and HighOccNum>k₂, it is determined that the current node is the first coding mode. In a case that LowOccNum>k₃ and HighOccNum<k₄, it is determined that the current node is the second coding mode.

In some embodiments, it is determined that the current node is a first coding mode in a case that the number of the low-plane occupancy child nodes is less than the first threshold. Alternatively, it is determined that the current node is a second coding mode in a case that the number of the high-plane occupancy child nodes is less than the second threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node.

For example, a first threshold k₁ and a second threshold k₂ are set. A low-plane occupancy child node LowOccNum and a high-plane occupancy child node HighOccNum are statistically obtained. In a case that LowOccNum<k₁, it is determined that the geometry mode of the current node is the first coding mode. In a case that HighOccNum<k₂, it is determined that the geometry mode of the current node is the second coding mode.

In some embodiments, it is determined that the current node is a first coding mode in a case that the to-be-coded child node is in a high plane, the number of the low-plane occupancy child nodes is less than the first threshold, and the number of the high-plane occupancy child nodes is greater than the second threshold. Alternatively, it is determined that the current node is a second coding mode in a case that the to-be-coded child node is in a low plane, the number of the low-plane occupancy child nodes is greater than the third threshold, and the number of the high-plane occupancy child nodes is less than the fourth threshold. The low-plane occupancy child node is a low-plane occupied child node of the reference node. The high-plane occupancy child node is a high-plane occupied child node of the reference node. Alternatively, the low-plane occupancy child node is a low-plane occupied child node of a reference node meeting a preset condition. The high-plane occupancy child node is a high-plane occupied child node of the reference node meeting the preset condition. The preset condition is configured for indicating that the reference node is a high-plane node or a low-plane node. The to-be-coded child node is a current to-be-coded child node in the current node.

For example, a first threshold k₁, a second threshold k₂, a third threshold k₃, and a fourth threshold k₄ are set. A low-plane occupancy child node LowOccNum and a high-plane occupancy child node HighOccNum are statistically obtained. In a case that the to-be-coded child node is in a high plane, LowOccNum<k₁, and HighOccNum>k₂, it is determined that the current node is the first coding mode. In a case that the to-be-coded child node is in a low plane, LowOccNum>k₃, and HighOccNum<k₄, it is determined that the current node is the second coding mode.

The foregoing method shows a method for determining the geometry mode of the current node based on the to-be-coded child node and an occupancy status of the child node of the reference node. Furthermore, the geometry mode of the current node may alternatively be determined based on the to-be-coded child node and at least one first node. For example, the geometry mode of the current node is determined based on the to-be-coded child node, the occupancy status of the child node of the reference node, and the coded child node of the current node. This disclosure does not limit use of the first node alone or in combination.

In some embodiments, the geometry mode of the current node is determined based on geometry information of the coded child node of the current node.

In some embodiments, the geometry mode of the current node is determined based on the geometry information of the reference node and the geometry information of the coded child node of the current node. For example, it is determined that the geometry mode of the current node is a first coding mode in a case that the coded child node of the current node and the reference node are not in the same plane and the to-be-coded child node and the coded child node of the current node are not in the same plane. Alternatively, it is determined that the geometry mode of the current node is a second coding mode in a case that the coded child node of the current node and the reference node are not in the same plane and the to-be-coded child node and the coded child node of the current node are in the same plane. Alternatively, it is determined that the geometry mode of the current node is a third coding mode in a case that the coded child node of the current node and the reference node are in the same plane and the to-be-coded child node and the coded child node of the current node are in the same plane. Alternatively, it is determined that the geometry mode of the current node is a fourth coding mode in a case that the coded child node of the current node and the reference node are in the same plane and the to-be-coded child node and the coded child node of the current node are not in the same plane.

In some embodiments, the reference node does not satisfy a planar mode. It is determined that a geometry mode of the to-be-coded child node is a fifth coding mode in a case that the coded child node of the current node is in the same plane and the to-be-coded child node and the coded child node of the current node are also in the same plane.

In some embodiments, the geometry mode of the current node is determined based on geometry information of the parent node of the current node. Alternatively, the geometry mode of the current node is determined based on geometry information of a child node of a reference node located at a same parent node as the current node. Alternatively, the geometry mode of the current node is determined based on geometry information of a child node of a neighbor node located at a same parent node as the current node. Alternatively, the geometry mode of the current node is determined based on geometry information of the neighbor node located at the same parent node as the current node.

In some embodiments, the at least one threshold is determined based on at least one of the following values:
a first value determined from the coder;
a second value obtained through parsing from a parameter set or a code stream corresponding to the current node;
a third value determined based on first information and/or second information; or
a fourth value adaptively determined based on the first information and/or the second information.

The first information is configured for indicating a statistical characteristic or space information of the current node. The second information is configured for indicating a statistical characteristic of a coded node.

To be specific, the first value may be a default value or a preset value of the coder. The second value is a value obtained from a parameter set or a code stream corresponding to the current node. For example, the parameter set includes a sequence parameter set (SMS), a geometry parameter set (GPS), an attribute parameter set (APS), a geometry header brick (GHB), and an attribute header brick (AHB). For example, a value planarOccNumTh is obtained from the parameter set or the code stream, to determine the second value.

In some embodiments, the first information includes at least one type of the following information:
a number of reference nodes meeting a preset condition;
a number of child nodes of the reference nodes meeting the preset condition;
a number distribution of the child nodes of the reference nodes meeting the preset condition; or
a position relationship between the child nodes of the reference nodes meeting the preset condition and the to-be-coded child node of the current node.

The preset condition is configured for indicating that the reference node is a high-plane node or a low-plane node.

The high-plane node is a node in which occupied child nodes are all in a high plane. The low-plane node is a node in which occupied child nodes are all in a low plane. Alternatively, the high-plane node satisfies that a number of occupied child nodes in a low plane is less than a number of first child nodes and a number of occupied child nodes in a high plane is greater than a number of second child nodes. The low-plane node satisfies that the number of occupied child nodes in the low plane is greater than a number of third child nodes and the number of occupied child nodes in the high plane is less than a number of fourth child nodes. The number of first child nodes, the number of second child nodes, the number of third child nodes, and the number of fourth child nodes are preset values.

In some embodiments, the second information includes at least one type of the following information:
a number of nodes satisfying a planar mode in the coded node;
a number of reference nodes satisfying the planar mode in the coded node;
a number of child nodes of the reference nodes satisfying the planar mode in the coded node;
a ratio of the number of the reference nodes satisfying the planar mode in the coded node to a number of non-null reference nodes; or
a ratio of the number of child nodes that are in the coded node and that satisfy the reference node of the planar mode to the number of the reference nodes.

In some embodiments, the second information includes at least one type of the following information:
a number of reference nodes corresponding to nodes satisfying a planar mode in the coded node;
a number of child nodes of the reference nodes corresponding to the nodes satisfying the planar mode in the coded node;
a ratio of the number of the reference nodes corresponding to the nodes satisfying the planar mode in the coded node to a number of non-null reference nodes corresponding to the nodes satisfying the planar mode; or
a ratio of the number of the child nodes of the reference nodes corresponding to the nodes satisfying the planar mode in the coded node to the number of the reference nodes.

The third value is a value determined based on the first information and/or the second information. Alternatively, the third value may be determined based on another information. For example, the third value is determined by using a point cloud slice volume density (a ratio of a point cloud slice volume or area to a point number): determining a point cloud slice volume density Q₁ from the coder, the parameter set, or the code stream, and in a case that the point cloud slice volume density is less than Q₁, determining that the third value is k₁; otherwise, determining that the third value is k₂.

The fourth value is determined in an adaptive mode based on the first information and/or the second information. The adaptive mode means that the fourth value is adjusted according to the obtained first information and/or second information.

In some embodiments, the fourth value is adjusted according to the first information. For example, if the number of reference nodes meeting a preset condition is greater than N₁, the fourth value a is adjusted to a=a+1. For another example, in a case that the number of child nodes of the reference node meeting the preset condition is less than N₂, the fourth value a is adjusted to a=a−1.

In some embodiments, spacing D₁ for statistically obtaining the second information is set. For every D₁ coded nodes, the second information is statistically obtained. In some other embodiments, spacing D₂ for statistically obtaining the second information is set. For every D₂ coded nodes, the second information of a non-null node is statistically obtained.

In some embodiments, before operation 840, a planar-eligible of the current node is determined. For example, the planar-eligible of the current node is determined based on the second node. After it is determined that the current node has the planar-eligible, determining of the geometry mode in operation 840 is performed.

For example, a planar-eligible of the current node is determined based on geometry information of a second node, where the planar-eligible is configured for indicating whether a planar mode is applicable to the current node. The second node is the same as or different from the first node. The second node is at least one of the following nodes: a reference node; a child node of the reference node; a coded child node of the current node; or a to-be-coded child node of the current node.

For example, the planar-eligible of the current node is determined based on a number of non-null nodes in the reference node. Alternatively, the planar-eligible of the current node is determined based on an occupancy status of the child node of the reference node. Alternatively, the planar-eligible of the current node is determined based on an occupancy status of the coded child node of the reference node.

In conclusion, according to the method provided in this embodiment of this disclosure, a geometry mode of a current node is determined by obtaining geometry information provided by a first node corresponding to a current node. In combination with information in an octree partition process, the geometry mode of the current node is optimally determined, so that coding may be performed according to an entropy coding mode corresponding to the geometry mode, thereby improving efficiency of coding and decoding point cloud data.

The decoding of point cloud data corresponds to the coding of point cloud data. To be specific, the geometry mode determining method performed by the coder device also corresponds to the geometry mode determining method performed by the decoder device. For detailed descriptions of the operations performed by the coder device, refer to the descriptions of the operations performed by the decoder device, and details are not described herein again.

The following describes apparatus embodiments of this disclosure, which may be configured to perform the method embodiments of this disclosure. For details not disclosed in the apparatus embodiments of this disclosure, refer to the method embodiments of this disclosure.

FIG. 17 shows a block diagram of a geometry mode determining apparatus according to an embodiment of this disclosure. The apparatus has a function of implementing the foregoing method examples. The function may be implemented by hardware or may be implemented by hardware executing corresponding software. The apparatus may be a computer device described above or may be disposed on the computer device. The computer device may be implemented as a decoder device. The apparatus may include: an obtaining module 620 and a determining module 630.

The obtaining module 620 is configured to obtain geometry information of a first node.

The determining module 630 is configured to determine a geometry mode of a current node according to the geometry information of the first node, where the current node is a current to-be-decoded node. The first node is at least one of the following nodes: a reference node; a child node of the reference node; a decoded child node of the current node; or a to-be-decoded child node of the current node.

In an implementation example, the determining module 630 is configured to determine the geometry mode of the current node based on at least one threshold and the geometry information of the first node.

In an implementation example, the first node includes the child node of the reference node and the to-be-decoded child node of the current node. The determining module 630 is configured to determine the geometry mode of the current node based on the at least one threshold, the child node of the reference node, and geometry information of the to-be-decoded child node of the current node.

In an implementation example, the child node of the reference node includes low-plane occupancy child nodes and high-plane occupancy child nodes. The determining module 630 is configured to statistically obtain a number of the low-plane occupancy child nodes and a number of the high-plane occupancy child nodes, and determine the geometry mode of the current node based on the at least one threshold, the geometry information of the to-be-decoded child node, the number of the low-plane occupancy child nodes, and the number of the high-plane occupancy child nodes.

In an implementation example, the at least one threshold includes a first threshold, a second threshold, a third threshold, and a fourth threshold.

In an implementation example, the determining module 630 is configured to: determine that the current node is a first decoding mode in a case that the number of the low-plane occupancy child nodes is less than the first threshold and the number of the high-plane occupancy child nodes is greater than the second threshold; or determine that the current node is a second decoding mode in a case that the number of the low-plane occupancy child nodes is greater than the third threshold and the number of the high-plane occupancy child nodes is less than the fourth threshold. The low-plane occupancy child node is a low-plane occupied child node of the reference node or a reference node meeting a preset condition. The high-plane occupancy child node is a high-plane occupied child node of the reference node or the reference node meeting the preset condition. The preset condition is configured for indicating that the reference node is a high-plane node or a low-plane node.

In an implementation example, the determining module 630 is configured to: determine that the current node is a first decoding mode in a case that the number of the low-plane occupancy child nodes is less than the first threshold; or determine that the current node is a second decoding mode in a case that the number of the high-plane occupancy child nodes is less than the second threshold. The low-plane occupancy child node is a low-plane occupied child node of the reference node or a reference node meeting a preset condition. The high-plane occupancy child node is a high-plane occupied child node of the reference node or the reference node meeting the preset condition. The preset condition is configured for indicating that the reference node is a high-plane node or a low-plane node.

In an implementation example, the determining module 630 is configured to: determine that the current node is a first decoding mode in a case that the to-be-decoded child node is in a high plane, the number of the low-plane occupancy child nodes is less than the first threshold, and the number of the high-plane occupancy child nodes is greater than the second threshold; or determine that the current node is a second decoding mode in a case that the to-be-decoded child node is in a low plane, the number of the low-plane occupancy child nodes is greater than the third threshold, and the number of the high-plane occupancy child nodes is less than the fourth threshold. The low-plane occupancy child node is a low-plane occupied child node of the reference node or a reference node meeting a preset condition. The high-plane occupancy child node is a high-plane occupied child node of the reference node or the reference node meeting the preset condition. The to-be-decoded child node is a child node to be decoded currently in the current node. The preset condition is configured for indicating that the reference node is a high-plane node or a low-plane node.

In an implementation example, the determining module 630 is configured to: define an initialized number of reference nodes meeting a preset condition and an offset value meeting a condition; determine, based on a geometry occupancy code mapping table and the offset value meeting the condition, a low-plane occupancy code in the reference nodes and a high-plane occupancy code in the reference nodes; increase, according to the low-plane occupancy code in the reference nodes and the high-plane occupancy code in the reference nodes, the initialized number of the reference nodes meeting the preset condition, to obtain a number of the reference nodes meeting the preset condition; check each of the low-plane occupancy code in the reference nodes and the high-plane occupancy code in the reference nodes, to separately obtain an intermediate number of the low-plane occupancy child nodes and an intermediate number of the high-plane occupancy child nodes; and separately assign, based on a magnitude relationship between the number of the reference nodes meeting the preset condition and a preset value, values to the intermediate number of the low-plane occupancy child nodes and the intermediate number of the high-plane occupancy child nodes, to obtain the number of the low-plane occupancy child nodes and the number of the high-plane occupancy child nodes.

In an implementation example, the determining module 630 is configured to determine the geometry mode of the current node based on geometry information of the decoded child node of the current node.

In an implementation example, the determining module 630 is configured to: determine that the to-be-decoded child node is a first decoding mode in a case that the decoded child node of the current node and the reference node are not in the same plane and the to-be-decoded child node and the decoded child node of the current node are not in the same plane; or determine that the to-be-decoded child node is a second decoding mode in a case that the decoded child node of the current node and the reference node are not in the same plane and the to-be-decoded child node and the decoded child node of the current node are in the same plane; or determine that the to-be-decoded child node is a third decoding mode in a case that the decoded child node of the current node and the reference node are in the same plane and the to-be-decoded child node and the decoded child node of the current node are in the same plane; or determine that the to-be-decoded child node is a fourth decoding mode in a case that the decoded child node of the current node and the reference node are in the same plane and the to-be-decoded child node and the decoded child node of the current node are not in the same plane.

In an implementation example, the reference node does not satisfy a planar mode. The determining module 630 is configured to determine that the to-be-decoded child node is a fifth decoding mode in a case that the decoded child node of the current node is in the same plane and the to-be-decoded child node and the decoded child node of the current node are also in the same plane.

In an implementation example, the at least one threshold is determined based on at least one of the following values: a first value determined from the decoder; a second value obtained through parsing from a parameter set or a code stream corresponding to the current node; a third value determined based on first information and/or second information; or a fourth value adaptively determined based on the first information and/or the second information. The first information is configured for indicating a statistical characteristic or space information of the current node. The second information is configured for indicating a statistical characteristic of a decoded node.

In an implementation example, the first information includes at least one type of the following information: a number of reference nodes meeting a preset condition; a number of child nodes of the reference nodes meeting the preset condition; a number distribution of the child nodes of the reference nodes meeting the preset condition; or a position relationship between the child nodes of the reference nodes meeting the preset condition and the to-be-decoded child node of the current node. The preset condition is configured for indicating that the reference node is a high-plane node or a low-plane node.

In an implementation example, the high-plane node is a node in which occupied child nodes are all in a high plane, and the low-plane node is a node in which occupied child nodes are all in a low plane. Alternatively, the high-plane node satisfies that a number of occupied child nodes in a low plane is less than a number of first child nodes and a number of occupied child nodes in a high plane is greater than a number of second child nodes. The low-plane node satisfies that the number of occupied child nodes in the low plane is greater than a number of third child nodes and the number of occupied child nodes in the high plane is less than a number of fourth child nodes. The number of first child nodes, the number of second child nodes, the number of third child nodes, and the number of fourth child nodes are preset values.

In an implementation example, the second information includes at least one type of the following information: a number of nodes satisfying a planar mode in the decoded node; a number of reference nodes satisfying the planar mode in the decoded node; a number of child nodes of the reference nodes satisfying the planar mode in the decoded node; a ratio of the number of the reference nodes satisfying the planar mode in the decoded node to a number of non-null reference nodes; or a ratio of the number of the child nodes of the reference nodes satisfying the planar mode in the decoded node to the number of the reference nodes.

In an implementation example, the second information includes at least one type of the following information: a number of reference nodes corresponding to nodes satisfying a planar mode in the decoded node; a number of child nodes of the reference nodes corresponding to the nodes satisfying the planar mode in the decoded node; a ratio of the number of the reference nodes corresponding to the nodes satisfying the planar mode in the decoded node to a number of non-null reference nodes corresponding to the nodes satisfying the planar mode; or a ratio of the number of the child nodes of the reference nodes corresponding to the nodes satisfying the planar mode in the decoded node to the number of the reference nodes.

In an implementation example, the determining module 630 is configured to: determine the reference node based on geometry information of a parent node of the current node; or determine the reference node based on geometry information of a child node of a neighbor node located at a same parent node as the current node; or determine the reference node based on geometry information of the neighbor node located at the same parent node as the current node.

In an implementation example, the reference node is selected from at least one of the following nodes: a decoded node; a non-null decoded node; a decoded node on a same layer as the current node or a non-null decoded node on a same layer as the current node; a decoded node at a fixed position; a non-null decoded node at a fixed position; a parent node of the current node; a neighbor node located at a same parent node as the current node; or a child node of the neighbor node located at the same parent node as the current node.

In an implementation example, the decoded node at the fixed position includes at least one of the following: a decoded node corresponding to the current node being offset by a first preset quantity in a direction of a first coordinate axis, where the first preset quantity is a preset offset quantity of the offset in the direction of the first coordinate axis; a decoded node corresponding to the current node being offset by a second preset quantity in a direction of a second coordinate axis, where the second preset quantity is a preset offset quantity of the offset in the direction of the second coordinate axis; or a decoded node corresponding to the current node being offset by a third preset quantity in the direction of the first coordinate axis and offset by a fourth preset quantity in the direction of the second coordinate axis, where the third preset quantity is a preset offset quantity of the offset in the direction of the first coordinate axis and the fourth preset quantity is a preset offset quantity of the offset in the direction of the second coordinate axis. The first coordinate axis and the second coordinate axis are coordinate axes in two different directions in a three-dimensional coordinate system.

In an implementation example, at least one of the first preset quantity, the second preset quantity, the third preset quantity, and the fourth preset quantity is: a default value or value group; or, a corresponding value or value group when a second condition is met; or, determined based on the met second condition; or, determined according to at least one type of information.

In an implementation example, at least one of the first preset quantity, the second preset quantity, the third preset quantity, and the fourth preset quantity varies based on a corresponding offset value variation, where the offset value variation is: a default value or value group; or, a corresponding value or value group when a second condition is met; or, determined based on the met second condition; or, determined according to at least one type of information.

In an implementation example, the decoded node at the fixed position is selected from at least one of the following: a decoded node corresponding to an offset of the current node in the direction of the first coordinate axis being less than a first offset threshold, where the first offset threshold is a preset maximum offset quantity of the offset in the direction of the first coordinate axis; a decoded node corresponding to an offset of the current node in the direction of the second coordinate axis being less than a second offset threshold, where the second offset threshold is a preset maximum offset quantity of the offset in the direction of the second coordinate axis; or a decoded node corresponding to a sum of the offset of the current node in the direction of the first coordinate axis and the offset in the direction of the second coordinate axis being less than a third offset threshold, where the third offset threshold is a preset maximum sum of the offset quantities of the offsets in the direction of the second coordinate axis and in the direction of the second coordinate axis. The first coordinate axis and the second coordinate axis are coordinate axes in two different directions in a three-dimensional coordinate system.

In an implementation example, the decoded node at the fixed position is selected by: selecting, in a first order, a fixed number of decoded nodes meeting a first condition, where the first order is at least one of a preset order, a default order, a linear order, a Hilbert order, a Morton order, or a coordinate axis order.

In an implementation example, at least one of the first offset threshold, the second offset threshold, the third offset threshold, and the fourth offset threshold is: a default value or value group; or, a corresponding value or value group when a second condition is met; or, determined based on the met second condition; or, determined according to at least one type of information.

In an implementation example, at least one of the direction of the first coordinate axis and the direction of the second coordinate axis is: a default coordinate axis direction; or, a corresponding coordinate axis direction when a second condition is met; or, determined based on the met second condition; or, determined according to at least one type of information.

In an implementation example, the second condition is related to at least one type of the following information: geometry slice information; a relative position of the current node; or occupancy information of a parent node of the current node; occupancy information of a neighbor node of the current node; or occupancy information of first k reference nodes.

In an implementation example, the at least one type of information includes at least one type of the following information: a quantization parameter; a data geometry precision; a geometry slice density; a geometry slice size; occupancy information of the reference node; a relative position of the current node; or a parent node and a neighbor node of the current node.

In an implementation example, the determining module 630 is further configured to: determine a selection mode of a subsequent reference node based on a number of non-null nodes in the selected reference nodes; or determine a selection mode of the subsequent reference node based on a number interval within which the number of non-null nodes in the selected reference nodes falls; or determine a selection mode of the subsequent reference node based on at least one threshold and the number of non-null nodes in the selected reference nodes.

In an implementation example, the determining module 630 is configured to determine a planar-eligible of the current node based on geometry information of a second node, where the planar-eligible is configured for indicating whether a planar mode is applicable to the current node. The second node is the same as or different from the first node, and the second node is at least one of the following nodes: a reference node; a child node of the reference node; a decoded child node of the current node; or a to-be-decoded child node of the current node.

In an implementation example, the determining module 630 is configured to: determine the planar-eligible of the current node based on a number of non-null nodes in the reference node; or determine the planar-eligible of the current node based on an occupancy status of the child node of the reference node; or determine the planar-eligible of the current node based on an occupancy status of the decoded child node of the reference node.

In an implementation example, the determining module 630 is configured to determine whether the current node is decoded by using a geometry mode.

In an implementation example, the determining module 630 is configured to perform any one of the following operations: determining, at a point cloud or point cloud slice level, whether the current node is decoded by using the geometry mode; determining, at a macro-block level, whether the current node is decoded by using the geometry mode; or determining, at a depth level of an octree, whether the current node is decoded by using the geometry mode.

In an implementation example, the determining module 630 is configured to perform any one of the following operations: determining, according to a decoding mode adopted by the decoder, whether the current node is decoded by using the geometry mode; determining, according to a parameter set or a code stream corresponding to the current node, whether the current node is decoded by using the geometry mode; or determining, according to a geometry mode threshold parameter, whether the current node is decoded by using the geometry mode, where the geometry mode threshold parameter is a threshold parameter obtained according to the decoder, the parameter set, or the code stream.

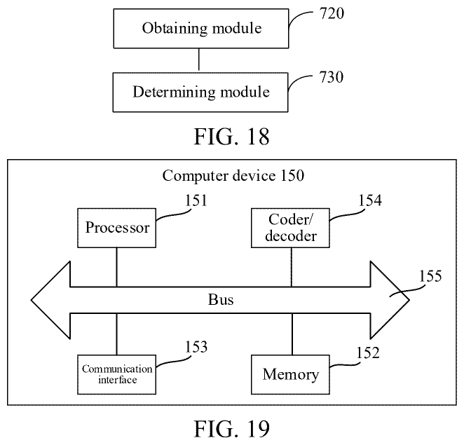

FIG. 18 shows a block diagram of a geometry mode determining apparatus according to an embodiment of this disclosure. The apparatus has a function of implementing the foregoing method examples. The function may be implemented by hardware or may be implemented by hardware executing corresponding software. The apparatus may be a computer device described above or may be disposed on the computer device. The computer device may be implemented as a coder device. The apparatus may include: an obtaining module 720 and a determining module 730.

The obtaining module 720 is configured to obtain geometry information of a first node.

The determining module 730 is configured to determine a geometry mode of a current node according to the geometry information of the first node, where the current node is a current to-be-coded node. The first node is at least one of the following nodes: a reference node; a child node of the reference node; a decoded child node of the current node; or a to-be-decoded child node of the current node.

When the apparatus provided in the foregoing embodiments is illustrated with an example of partition of the foregoing function modules during the implementation of the functions thereof. In practical application, the foregoing functions may be allocated to and completed by different function modules according to requirements. To be specific, an internal structure of a device is partitioned into different function modules, to complete all or part of the functions described above. In addition, the apparatus provided in the foregoing embodiments belongs to the same conception as the method embodiments. For a specific implementation process thereof, refer to the method embodiments. Details are not described herein again.

FIG. 19 shows a structural block diagram of a computer device according to an embodiment of this disclosure. The computer device may be the coder device described above, or may be the decoder device described above. The computer device 150 may include: a processor 151, a memory 152, a communication interface 153, a coder/decoder 154, and a bus 155. When the computer device is implemented as a coder device, the computer device includes the coder 154. When the computer device is implemented as a decoder device, the computer device includes the decoder 154.

The processor 151 includes one or more processing cores. The processor 151 runs a software program and module, to implement various function applications and information processing. The memory 152 may be configured to store a computer program. The processor 151 is configured to execute the computer program, to implement the foregoing geometry mode determining method. The communication interface 153 may be configured to communicate with another device, for example, receive and transmit audio and video data. The coder/decoder 154 may be configured to implement coding and decoding functions, for example, coding and decoding the audio and video data. The coder 154 is configured to implement the coding function and/or each coding operation in the foregoing method embodiments. The decoder 154 is configured to implement the decoding function and/or each decoding operation in the foregoing method embodiments. The memory 152 is connected to the processor 151 through the bus 155.

Furthermore, the memory 152 may be implemented by any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

The structure shown in FIG. 19 constitutes no limitation on the computer device 150. The computer device may include more or fewer components than those shown in the figure, or some components may be combined, or a different component deployment may be used.

In an embodiment, a computer-readable storage medium is further provided. The computer-readable storage medium has at least one instruction, at least one program, a code set, or an instruction set stored therein. The at least one instruction, the at least one program, the code set, or the instruction set, when executed by a processor, implements the foregoing geometry mode determining method.

In an embodiment, a computer program product or a computer program is further provided. The computer program product or the computer program includes computer instructions. The computer instructions are stored in a computer-readable storage medium. A processor of a computer device reads the computer instructions from the computer-readable storage medium. The processor executes the computer instructions, to cause the computer device to perform the foregoing geometry mode determining method.

“Plurality of” mentioned in this specification means two or more. The term “and/or” describes an association relationship between associated objects and indicates that three relationships may exist. For example, A and/or B may indicate the following three cases: A alone, both A and B, and B alone. The character “/” in this specification generally indicates an “or” relationship between the associated objects. In addition, the operation numbers described in this specification merely exemplarily show an execution order of the operations in some examples. In some other embodiments, the operations may not be performed according to the number order. For example, two operations with different numbers may be performed simultaneously, or two operations with different numbers may be performed according to an order contrary to the order shown in the figure. This is not limited in this embodiment of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely examples of embodiments of this disclosure, and are not intended to limit this disclosure. Any modification, equivalent replacement, improvement, and the like made within the spirit and principle of this disclosure are included within the scope of this disclosure.

What is claimed is:

1. A method of point cloud decoding by a decoder, the method comprising:
receiving a bitstream of coded information of a point cloud;
obtaining, according to the coded information, respective geometry information of a plurality of first nodes in the point cloud; and
determining a geometry mode of a current node according to the respective geometry information of the plurality of first nodes, wherein:
the current node is a current to-be-decoded node in the point cloud; and
the plurality of first nodes comprises at least one of a reference node of the current node, a child node of the reference node, a decoded child node of the current node, and/or a to-be-decoded child node of the current node.

2. The method according to claim 1, wherein:
the plurality of first nodes comprises one or more child nodes of the reference node and the to-be-decoded child node of the current node; and
the determining includes determining the geometry mode of the current node based on:
at least one threshold,
first geometry information of the one or more child nodes of the reference node, and
second geometry information of the to-be-decoded child node of the current node.

3. The method according to claim 2, wherein the determining comprises:
obtaining a first counting number for low-plane occupancy child nodes in the one or more child nodes of the reference node and a second counting number for high-plane occupancy child nodes in the one or more child nodes of the reference node based on the first geometry information of the one or more child nodes of the reference node; and
determining the geometry mode of the current node based on:
the at least one threshold,
the second geometry information of the to-be-decoded child node,
the first counting number, and
the second counting number.

4. The method according to claim 3, wherein:
the at least one threshold comprises a first threshold, a second threshold, a third threshold, and a fourth threshold, and
the determining comprises:
determining that the current node is to be decoded according to a first decoding mode when the to-be-decoded child node of the current node is in a high plane, the first counting number of the low-plane occupancy child nodes of the reference node is less than the first threshold, and the second counting number of the high-plane occupancy child nodes of the reference node is greater than the second threshold; and
determining that the current node is to be decoded according to a second decoding mode when the to-be-decoded child node of the current node is in a low plane, the first counting number of the low-plane occupancy child nodes of the reference node is greater than the third threshold, and the second counting number of the high-plane occupancy child nodes of the reference node is less than the fourth threshold.

5. The method according to claim 3, wherein:
the plurality of first nodes comprises a plurality of reference nodes, and
the obtaining comprises:
initializing a counting number for qualified reference nodes,
setting offset values for positions of the plurality of reference nodes;
determining, based on a geometry occupancy code mapping table and the offset values, respective low-plane occupancy codes of the plurality of reference nodes and respective high-plane occupancy codes of the plurality of reference nodes;
updating the counting number for the qualified reference nodes according to the respective low-plane occupancy codes of the plurality of reference nodes and the respective high-plane occupancy codes of the plurality of reference nodes, a qualified reference node being a reference node that meets a preset condition;
obtaining a first intermediate number for low-plane occupancy child nodes of the plurality of reference nodes and a second intermediate number for high-plane occupancy child nodes of the plurality of reference nodes; and
determining the first counting number and the second counting number based on the counting number of the qualified reference nodes, the first intermediate number for the low-plane occupancy child nodes of the plurality of reference nodes and the second intermediate number for the high-plane occupancy child nodes of the plurality of reference nodes.

6. The method according to claim 1, wherein the determining the geometry mode of the current node comprises:
determining the geometry mode of the current node based on at least first geometry information of the decoded child node of the current node.

7. The method according to claim 6, wherein the determining the geometry mode of the current node comprises:
determining that the current node is to be decoded according to a first decoding mode when the decoded child node of the current node and the reference node are not in a same plane and the to-be-decoded child node and the decoded child node of the current node are not in a same plane;
determining that the current node is to be decoded according to a second decoding mode when the decoded child node of the current node and the reference node are not in a same plane and the to-be-decoded child node and the decoded child node of the current node are in a same plane;
determining that the current node is to be decoded according to a third decoding mode when the decoded child node of the current node and the reference node are in a same plane and the to-be-decoded child node and the decoded child node of the current node are in a same plane; and
determining that the current node is to be decoded according to a fourth decoding mode when the decoded child node of the current node and the reference node are in a same plane and the to-be-decoded child node and the decoded child node of the current node are not in a same plane.

8. The method according to claim 6, wherein:
the reference node is not coded in a planar mode; and
the determining the geometry mode of the current node comprises:
determining that the to-be-decoded child node is to be decoded according to a fifth decoding mode when a plurality of decoded child nodes of the current node are in a same plane and the to-be-decoded child node is in the same plane.

9. The method according to claim 2, wherein:
the at least one threshold is determined based on at least one of:
a first value derived by the decoder;
a second value that is parsed from a parameter set or coded information of the current node in the bitstream;
a third value that is determined based on first information and/or second information; and/or
a fourth value adaptively determined based on the first information and/or the second information,
the first information indicates a statistical characteristic or space information of the current node, and
the second information indicates a statistical characteristic of a decoded node.

10. The method according to claim 9, wherein the first information comprises at least one of:
a first counting number for a plurality of reference nodes that meets a preset condition;
a second counting number for child nodes of the plurality of reference nodes;
a number distribution for the child nodes of the plurality of reference nodes; and/or
a position relationship between the child nodes of the plurality of reference nodes and the to-be-decoded child node of the current node.

11. The method according to claim 10, wherein:
the preset condition is a condition to determine whether a node is a high-plane node or a condition to determine whether a node is a low-plane node.

12. The method according to claim 9, wherein the second information comprises at least one of:
a first counting number for decoded nodes that are of a planar mode;
a second counting number for a plurality of reference nodes of the planar mode;
a third counting number for child nodes of the plurality of reference nodes;
a first ratio of the second counting number to a counting number of non-null reference nodes; and/or
a second ratio of the third counting number to the second counting number.

13. The method according to claim 9, wherein the second information comprises at least one of:
a first counting number for a plurality of reference nodes corresponding to a plurality of decoded nodes of a planar mode;
a second counting number for child nodes of the plurality of reference nodes;
a first ratio of the first counting number to a counting number of non-null reference nodes corresponding to the plurality of decoded nodes of the planar mode; and/or
a second ratio of the second counting number to the first counting number.

14. The method according to claim 1, the method further comprising one of:
determining the reference node based on geometry information of a parent node of the current node;
determining the reference node based on geometry information of a child node of a neighbor node, the neighbor node having a same parent node as the current node; or
determining the reference node based on geometry information of the neighbor node.

15. The method according to claim 1, wherein the reference node is selected from at least one of:
a decoded node;
a non-null decoded node;
a decoded node on a same layer as the current node;
a non-null decoded node on a same layer as the current node;
a decoded node at a fixed position;
a non-null decoded node at a fixed position;
a parent node of the current node;
a neighbor node having a same parent node as the current node; and/or
a child node of the neighbor node having the same parent node as the current node.

16. The method according to claim 15, wherein:
the decoded node at the fixed position comprises at least one of:
a decoded node that is offset to the current node by a first preset quantity in a first direction of a first coordinate axis;
a decoded node that is offset to the current node by a second preset quantity in a second direction of a second coordinate axis; and/or
a decoded node that is offset to the current node by a third preset quantity in the first direction and by a fourth preset quantity in the second direction, and
the first coordinate axis and the second coordinate axis are coordinate axes in two different directions in a three-dimensional coordinate system.

17. The method according to claim 16, wherein at least one of the first preset quantity, the second preset quantity, the third preset quantity, and the fourth preset quantity are set according to:
one or more default values; or
one or more values associated with a second condition when the second condition is met.

18. The method according to claim 16, wherein at least one of the first preset quantity, the second preset quantity, the third preset quantity, and the fourth preset quantity are adjusted based on respective variations, the respective variations are set according to:
one or more default values; or
one or more values associated with a second condition when the second condition is met.

19. An information processing apparatus for point cloud decoding, the information processing apparatus comprising processing circuitry configured to:
receive a bitstream of coded information of a point cloud;
obtain, according to the coded information, respective geometry information of a plurality of first nodes in the point cloud; and
determine a geometry mode of a current node according to the respective geometry information of the plurality of first nodes, wherein:
the current node is a current to-be-decoded node in the point cloud; and
the plurality of first nodes comprises at least one of a reference node of the current node, a child node of the reference node, a decoded child node of the current node, and/or a to-be-decoded child node of the current node.

20. A non-transitory computer-readable storage medium storing instructions which when executed by at least one processor cause the at least one processor to perform:
receiving a bitstream of coded information of a point cloud;
obtaining, according to the coded information, respective geometry information of a plurality of first nodes in the point cloud; and
determining a geometry mode of a current node according to the respective geometry information of the plurality of first nodes, wherein:
the current node is a current to-be-decoded node in the point cloud; and
the plurality of first nodes comprise at least one of a reference node of the current node, a child node of the reference node, a decoded child node of the current node, and/or a to-be-decoded child node of the current node.
